(19) United States
(12) Patent Application Publication
(10) Pub. No.: US 2009/0019064 A1
(43) Pub. Date: Jan. 15, 2009

(54) DOCUMENT PROCESSING DEVICE AND DOCUMENT PROCESSING METHOD

(75) Inventor: Sunao Takafuji, Tokushima (JP)

Correspondence Address: SUGHRUE MION, PLLC, 2100 PENNSYLVANIA AVENUE, N.W., SUITE 800, WASHINGTON, DC, 20037, US

(73) Assignee: JUSTSYSTEMS CORPORATION, Tokushima-shi, Tokushima (JP)

(21) Appl. No.: 11/816,241

(22) PCT Filed: Feb. 1, 2006
(86) PCT No.: PCT/JP2006/301626

§ 371 Date: Aug. 14, 2007

(30) Foreign Application Priority Data
Feb. 14, 2005 (JP) 2005-035502

(51) Int. Cl. G06F 17/30

(52) U.S. Cl. 707/100; 707/E17.005

(57) ABSTRACT

Conveying knowledge by means of a document file is facilitated. A document processing apparatus acquires a source file, and classifies text data included in the source file by the context on the basis of a given criterion. The data thus extracted according to the context is stored in a database. A view file is created with the context according to a reader's mental model. The data to be the content of the view file and the layout thereof can be determined by a user who is the reader in an arbitrary manner.

### TECHNICAL FIELD

The present invention relates to data processing techniques and, in particular, to a technique for structuring and processing document data.

### BACKGROUND ART

Documents are steadily increasing together with progresses of IT in companies and advancements of the Internet. The documents produced in large quantities lead to the degradation of quality thereof in that the common understanding is difficult. Dispersion of related documents, being related to each other, in wide areas makes it difficult to manage the documents in a unified manner and reuse them.

### DISCLOSURE OF THE INVENTION

### Problems to be Solved by the Invention

To manage so increased documents in an efficient manner, document databases and document management systems have been developed and utilized. Such systems, however, manage the documents systematically and formally, by wholly managing a document that is unformatted information as a document object or predefining the scheme for using the document as a document attribute. For this reason, there are problems that the flexibility to respond to the change in the business environment is poor, the accuracy of document retrieval is low, reusability of the document is not enough, and so on.

The present invention provides a technique of structuring and processing data of a document file in an appropriate manner.

### Means for Solving the Problems

According to an aspect of the present invention, a document processing apparatus comprises: a document acquiring unit which acquires a document file from an external apparatus; a meta information extracting unit which refers to context information in which one or more contexts are defined as a segment for classifying data in accordance with a given criterion and extracts meta information in accordance with each context from the data included in the acquired document file; and a related information storage which stores related information representing that a group of the meta information corresponding to each context is the data extracted from the acquired document file.

According to another aspect of the present invention is also a document processing apparatus comprising: a document acquiring unit which acquires a document file to be browsed as a source file; a context analysis unit which refers to context information in which one or more contexts are defined as a segment for classifying data in accordance with a given criterion and extracts context data that matches each context from the source file; and a document creator which refers to a browsing condition, which is a condition designated by a reader, for identifying the one or more contexts to be browsed and defining a structure of the document file newly created from the context data that matches the each context, so as to create a view file as the document file in which the context data to be browsed is structured.

The document processing apparatus may further comprise an element analysis unit which extracts element data from the source file in units constituting a semantic structure of a text as a component of a sentence, wherein the context analysis unit may extract the context data including one or more pieces of the element data on the basis of the context formed by a group of the element data.

The context analysis unit may extract the context data from the source file on an item basis, the item being provided in the sentence.

Layout information for displaying may be applied to the source file; and the context analysis unit may extract the context data from the source file in a constitutional unit to be displayed on the layout information.

The apparatus may further comprise a display processor which refers to a display condition for defining a method of displaying the context data to be browsed, and identifies the method of displaying the view file.

The document creator may be adapted to create a single view file from the context data extracted from a plurality of types of the source files.

According to yet another aspect of the present invention, a document processing method comprises: acquiring a document file to be browsed as a source file; referring to context information in which one or more contexts are defined as a segment for classifying data in accordance with a given criterion to extract context data that matches each context from the source file; and referring to a browsing condition, which is a condition designated by a reader, for identifying the one or more contexts to be browsed and defining a structure of the document file newly created from the context data that matches the each context, so as to create a view file as the document file in which the context data to be browsed is structured.

Optional combinations of the aforementioned constituting elements and implementations of the present invention in the form of methods, processors, apparatus, systems, computer programs, data structures etc. may also be implemented as additional modes of the present invention.

### ADVANTAGEOUS EFFECTS

According to the present invention, a technique for structuring and processing data in a document file in an appropriate manner.

### BRIEF DESCRIPTION OF THE DRAWINGS

FIG. 1 is a diagram which shows a configuration of a document processing apparatus according to the Background Art;

FIG. 2 is a diagram which shows an example of an XML document which is a processing target;

FIG. 3 is a diagram which shows an example in which the XML document shown in FIG. 2 is mapped to a table described in HTML;

FIG. 4(a) is a diagram which shows an example of a definition file used for mapping the XML document shown in FIG. 2 to the table shown in FIG. 3;

FIG. 4(b) is a diagram which shows an example of a definition file used for mapping the XML document shown in FIG. 2 to the table shown in FIG. 3;

FIG. 5 is a diagram which shows an example of a screen on which the XML document, which has been described in a marks managing vocabulary and which is shown in FIG. 2, is displayed after having been mapped to HTML according to the correspondence shown in FIG. 3;

FIG. 6 is a diagram which shows an example of a graphical user interface provided by a definition file creating unit, which allows the user to create a definition file;

FIG. 7 is a diagram which shows another example of a screen layout created by the definition file creating unit;

FIG. 8 is a diagram which shows an example of an editing screen for an XML document, as provided by the document processing apparatus;

FIG. 9 is a diagram which shows another example of an XML document which is to be edited by the document processing apparatus;

FIG. 10 is a diagram which shows an example of a screen on which the document shown in FIG. 9 is displayed;

FIG. 11(a) is a diagram which shows a basic configuration of a document processing system;

FIG. 11(b) is a block diagram which shows an overall block configuration of a document processing system;

FIG. 11(c) is a block diagram which shows an overall block configuration of a document processing system;

FIG. 12 is a diagram which shows a document management unit in detail;

FIG. 13 is a diagram which shows a vocabulary connection sub-system in detail;

FIG. 14 is a diagram which shows a relation between a program invoker and other components in detail;

FIG. 15 is a diagram which shows a structure of an application service loaded to the program invoker in detail;

FIG. 16 is a diagram which shows a core component in detail;

FIG. 17 is a diagram which shows a document management unit in detail;

FIG. 18 is a diagram which shows an undo framework and an undo command in detail;

FIG. 19 is a diagram which shows the operation in which a document is loaded to the document processing system;

FIG. 20 is a diagram which shows an example of a document and a representation of the document;

FIG. 21 is a diagram which shows a relation between a model and a controller;

FIG. 22 is a diagram which shows a plug-in sub-system, a vocabulary connection, and a connector, in detail;

FIG. 23 is a diagram which shows an example of a VCD file;

FIG. 24 is a diagram which shows a procedure for loading a compound document to the document processing system;

FIG. 25 is a diagram which shows a procedure for loading a compound document to the document processing system;

FIG. 26 is a diagram which shows a procedure for loading a compound document to the document processing system;

FIG. 27 is a diagram which shows a procedure for loading a compound document to the document processing system;

FIG. 28 is a diagram which shows a procedure for loading a compound document to the document processing system;

FIG. 29 is a diagram which shows a command flow.

FIG. 30 is a schematic diagram which shows an information structure of a document;

FIG. 31 is a schematic diagram which shows an embodiment of the extraction and segments of the meta information;

FIG. 32 is a schematic diagram which shows the correspondence between the meta information and the context layer;

FIG. 33 is a schematic diagram which shows an embodiment of the document creation based on the reader's mental model;

FIG. 34 is a schematic diagram which shows the framework provided by the present system;

FIG. 35 is a schematic diagram which shows the correspondence between documents and contexts;

FIG. 36 is a schematic diagram which explains the principle of generating a view file from the source file;

FIG. 37 illustrates a functional block diagram of the document processing apparatus according to the present embodiment; and

FIG. 38 illustrates a screen for setting the configuration of the view file.

### REFERENCE NUMERALS

20 document processing apparatus, 22 main control unit, 24 editing unit, 30 DOM unit, 32 DOM provider, 34 DOM builder, 36 DOM writer, 40 CSS unit, 42 CSS parser, 44 CSS provider, 46 rendering unit, 50 HTML unit, 52, 62 control unit, 54, 64 editing unit, 56, 66 display unit, 60 SVG unit, 80 VC unit, 82 mapping unit, 84 definition file acquisition unit, 86 definition file creating unit, 3000 document space, 3010 source file, 3060 view file, 3100 document processing apparatus, 3120 document acquiring unit, 3140 analysis unit, 3160 element analysis unit, 3180 context analysis unit, 3200 data retaining unit, 3220 condition setting unit

### BEST MODE FOR CARRYING OUT THE INVENTION

### (Prerequisite Technology)

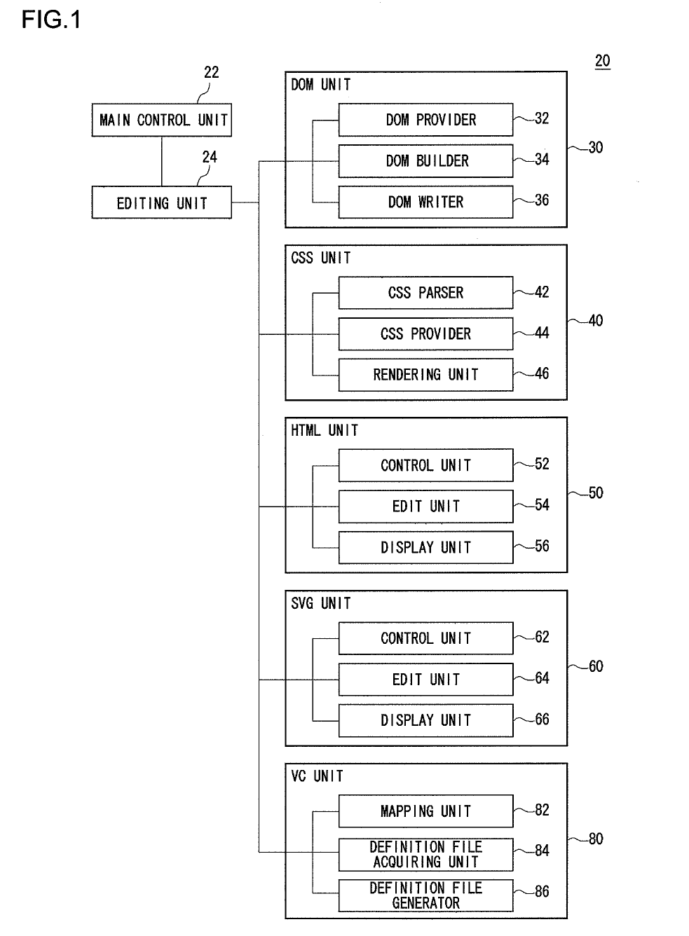

FIG. 1 illustrates a structure of a document processing apparatus 20 according to Prerequisite Technology. The document processing apparatus 20 processes a structured document where data in the document are classified into a plurality of components having a hierarchical structure. Represented in Prerequisite Technology is an example in which an XML document, as one type of a structured document, is processed. The document processing apparatus 20 is comprised of a main control unit 22, an editing unit 24, a DOM unit 30, a CSS unit 40, an HTML unit 50, an SVG unit 60 and a VC unit 80 which serves as an example of a conversion unit. In terms of hardware components, these unit structures may be realized by any conventional processing system or equipment, including a CPU or memory of any computer, a memory-loaded program, or the like. Here, the drawing shows a functional block configuration which is realized by cooperation between the hardware components and software components. Thus, it should be understood by a person skilled in the art that these functional blocks can be realized in a variety of forms by hardware only, software only or the combination thereof.

The main control unit 22 provides for the loading of a plug-in or a framework for executing a command. The editing unit 24 provides a framework for editing XML documents. Display and editing functions for a document in the document processing apparatus 20 are realized by plug-ins, and the necessary plug-ins are loaded by the main control unit 22 or the editing unit 24 according to the type of document under consideration. The main control unit 22 or the editing unit 24 determines which vocabulary or vocabularies describes the content of an XML document to be processed, by referring to a name space of the document to be processed, and loads a plug-in for display or editing corresponding to the thus determined vocabulary so as to execute the display or the editing. For instance, an HTML unit 50, which displays and edits HTML documents, and an SVG unit 60, which displays and edits SVG documents, are implemented in the document processing apparatus 20. That is, a display system and an editing system are implemented as plug-ins for each vocabulary (tag set), so that when an HTML document and an SVG document are edited, HTML unit 50 and the SVG unit 60 are loaded, respectively. As will be described later, when compound documents, which contain both HTML and SVG components, are to be processed, both HTML unit 50 and the SVG unit 60 are loaded.

By implementing the above structure, a user can select so as to install only necessary functions, and can add or delete a function or functions at a later stage, as appropriately. Thus, the storage area of a recording medium, such as a hard disk, can be effectively utilized, and the wasteful use of memory can be prevented at the time of executing programs. Furthermore, since the capability of this structure is highly expandable, a developer can deal with new vocabularies in the form of plug-ins, and thus the development process can be readily facilitated. As a result, the user can also add a function or functions easily at low cost by adding a plug-in or plug-ins.

The editing unit 24 receives an event, which is an editing instruction, from the user via the user interface. Upon reception of such an event, the editing unit 24 notifies a suitable plug-in or the like of this event, and controls the processing such as redoing this event, canceling (undoing) this event, etc.

The DOM unit 30 includes a DOM provider 32, a DOM builder 34 and a DOM writer 36. The DOM unit 30 realizes functions in compliance with a document object model (DOM), which is defined to provide an access method used for handling data in the form of an XML document. The DOM provider 32 is an implementation of a DOM that satisfies an interface defined by the editing unit 24. The DOM builder 34 creates DOM trees from XML documents. As will be described later, when an XML document to be processed is mapped to another vocabulary by the VC unit 80, a source tree, which corresponds to the XML document in a mapping source, and a destination tree, which corresponds to the XML document in a mapping destination, are created. At the end of editing, for example, the DOM writer 36 outputs a DOM tree as an XML document.

The CSS unit 40, which provides a display function conforming to CSS, includes a CSS parser 42, a CSS provider 44 and a rendering unit 46. The CSS parser 42 has a parsing function for analyzing the CSS syntax. The CSS provider 44 is an implementation of a CSS object and performs CSS cascade processing on the DOM tree. The rendering unit 46 is a CSS rendering engine and is used to display documents, described in a vocabulary such as HTML, which are laid out using CSS.

HTML unit 50 displays or edits documents described in HTML. The SVG unit 60 displays or edits documents described in SVG. These display/editing systems are realized in the form of plug-ins, and each system is comprised of a display unit (also designated herein as a “canvas”) 56 and 66, which displays documents, a control unit (also designated herein as an “editlet”) 52 and 62, which transmits and receives events containing editing commands, and an edit unit (also designated herein as a “zone”) 54 and 64, which edits the DOM according to the editing commands. Upon the control unit 52 or 62 receiving a DOM tree editing command from an external source, the edit unit 54 or 64 modifies the DOM tree and the display unit 56 or 66 updates the display. These units have a structure similar to the framework of the so-called MVC (Model-View-Controller). With such a structure, in general, the display units 56 and 66 correspond to “View”. On the other hand, the control units 52 and 62 correspond to “Controller”, and the edit units 54 and 64 and DOM instance corresponds to “Model”. The document processing apparatus 20 according to the Prerequisite Technology allows an XML document to be edited according to each given vocabulary, as well as providing a function of editing HTML document in the form of tree display. HTML unit 50 provides a user interface for editing an HTML document in a manner similar to a word processor, for example. On the other hand, the SVG unit 60 provides a user interface for editing an SVG document in a manner similar to an image drawing tool.

The VC unit 80 includes a mapping unit 82, a definition file acquiring unit 84 and a definition file generator 86. The VC unit 80 performs mapping of a document, which has been described in a particular vocabulary, to another given vocabulary, thereby providing a framework that allows a document to be displayed and edited by a display/editing plug-in corresponding to the vocabulary to which the document is mapped. In the Prerequisite Technology, this function is called a vocabulary connection (VC). In the VC unit 80, the definition file acquiring unit 84 acquires a script file in which the mapping definition is described. Here, the definition file specifies the correspondence (connection) between the Nodes for each Node. Furthermore, the definition file may specify whether or not editing of the element values or attribute values is permitted. Furthermore, the definition file may include operation expressions using the element values or attribute values for the Node. Detailed description will be made later regarding these functions. The mapping unit 82 instructs the DOM builder 34 to create a destination tree with reference to the script file acquired by the definition file acquiring unit 84. This manages the correspondence between the source tree and the destination tree. The definition file generator 86 offers a graphical user interface which allows the user to create a definition file.

The VC unit 80 monitors the connection between the source tree and the destination tree. Upon reception of an editing instruction from the user via a user interface provided by a plug-in that handles a display function, the VC unit 80 first modifies a relevant Node of the source tree. As a result, the DOM unit 30 issues a mutation event indicating that the source tree has been modified. Upon reception of the mutation event thus issued, the VC unit 80 modifies a Node of the destination tree corresponding to the modified Node, thereby updating the destination tree in a manner that synchronizes with the modification of the source tree. Upon reception of a mutation event that indicates that the destination tree has been modified, a plug-in having functions of displaying/editing the destination tree, e.g., HTML unit 50, updates a display with reference to the destination tree thus modified. Such a structure allows a document described in any vocabulary, even a minor vocabulary used in a minor user segment, to be converted into a document described in another major vocabulary. This enables such a document described in a minor vocabulary to be displayed, and provides an editing environment for such a document.

An operation in which the document processing apparatus 20 displays and/or edits documents will be described herein below. When the document processing apparatus 20 loads a document to be processed, the DOM builder 34 creates a DOM tree from the XML document. The main control unit 22 or the editing unit 24 determines which vocabulary describes the XML document by referring to a name space of the XML document to be processed. If the plug-in corresponding to the vocabulary is installed in the document processing apparatus 20, the plug-in is loaded so as to display/edit the document. If, on the other hand, the plug-in is not installed in the document processing apparatus 20, a check shall be made to see whether a mapping definition file exists or not. And if the definition file exits, the definition file acquiring unit 84 acquires the definition file and creates a destination tree according to the definition, so that the document is displayed/edited by the plug-in corresponding to the vocabulary which is to be used for mapping. If the document is a compound document containing a plurality of vocabularies, relevant portions of the document are displayed/edited by plug-ins corresponding to the respective vocabularies, as will be described later. If the definition file does not exist, a source or tree structure of a document is displayed and the editing is carried out on the display screen.

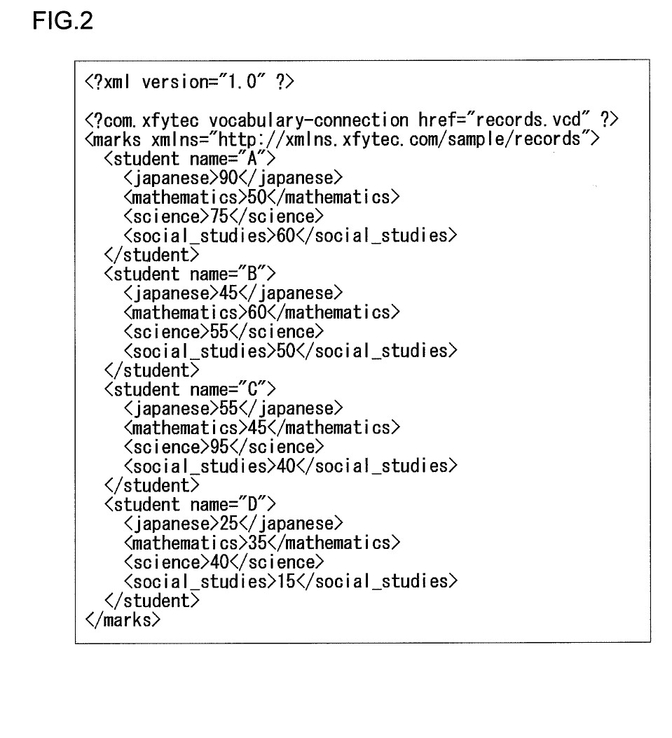

FIG. 2 shows an example of an XML document to be processed. According to this exemplary illustration, the XML document is used to manage data concerning grades or marks that students have earned. A component “marks”, which is the top Node of the XML document, includes a plurality of components “student” provided for each student under “marks”. The component “student” has an attribute “name” and contains, as child elements, the subjects “japanese”, “mathematics”, “science”, and “social_studies”. The attribute “name” stores the name of a student. The components “japanese”, “mathematics”, “science” and “social_studies” store the test scores for the subjects Japanese, mathematics, science, and social studies, respectively. For example, the marks of a student whose name is “A” are “90” for Japanese, “50” for mathematics, “75” for science and “60” for social studies. Hereinafter, the vocabulary (tag set) used in this document will be called “marks managing vocabulary”.

Here, the document processing apparatus 20 according to the Prerequisite Technology does not have a plug-in which conforms to or handles the display/editing of marks managing vocabularies. Accordingly, before displaying such a document in a manner other than the source display manner or the tree display manner, the above-described VC function is used. That is, there is a need to prepare a definition file for mapping the document, which has been described in the marks managing vocabulary, to another vocabulary, which is supported by a corresponding plug-in, e.g., HTML or SVG. Note that description will be made later regarding a user interface that allows the user to create the user's own definition file. Now, description will be made below regarding a case in which a definition file has already been prepared.

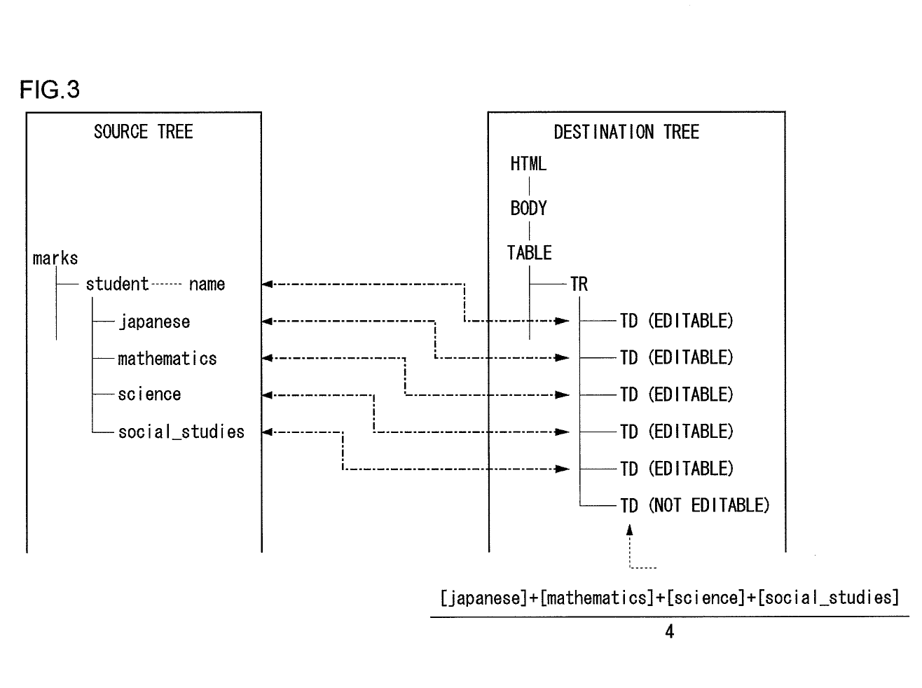

FIG. 3 shows an example in which the XML document shown in FIG. 2 is mapped to a table described in HTML. In an example shown in FIG. 3, a “student” Node in the marks managing vocabulary is associated with a row (“TR” Node) of a table (“TABLE” Node) in HTML. The first column in each row corresponds to an attribute value “name”, the second column to a “japanese” Node element value, the third column to a “mathematics” Node element value, the fourth column to a “science” Node element value and the fifth column to a “social_studies” Node element value. As a result, the XML document shown in FIG. 2 can be displayed in an HTML tabular format. Furthermore, these attribute values and element values are designated as being editable, so that the user can edit these values on a display screen using an editing function of HTML unit 50. In the sixth column, an operation expression is designated for calculating a weighted average of the marks for Japanese, mathematics, science and social studies, and average values of the marks for each student are displayed. In this manner, more flexible display can be effected by making it possible to specify the operation expression in the definition file, thus improving the users' convenience at the time of editing. In this example shown in FIG. 3, editing is designated as not being possible in the sixth column, so that the average value alone cannot be edited individually. Thus, in the mapping definition it is possible to specify editing or no editing so as to protect the users against the possibility of performing erroneous operations.

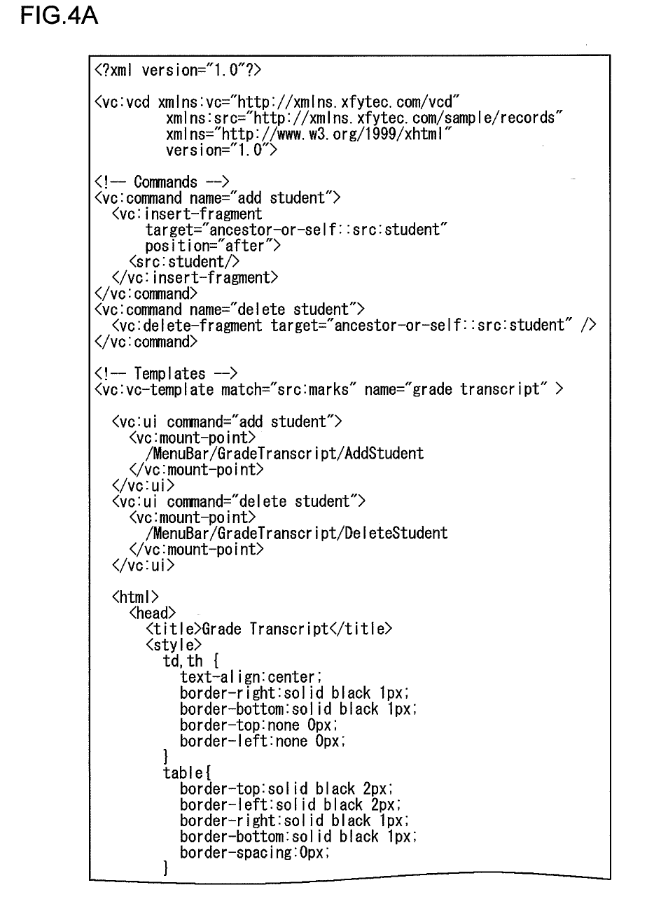

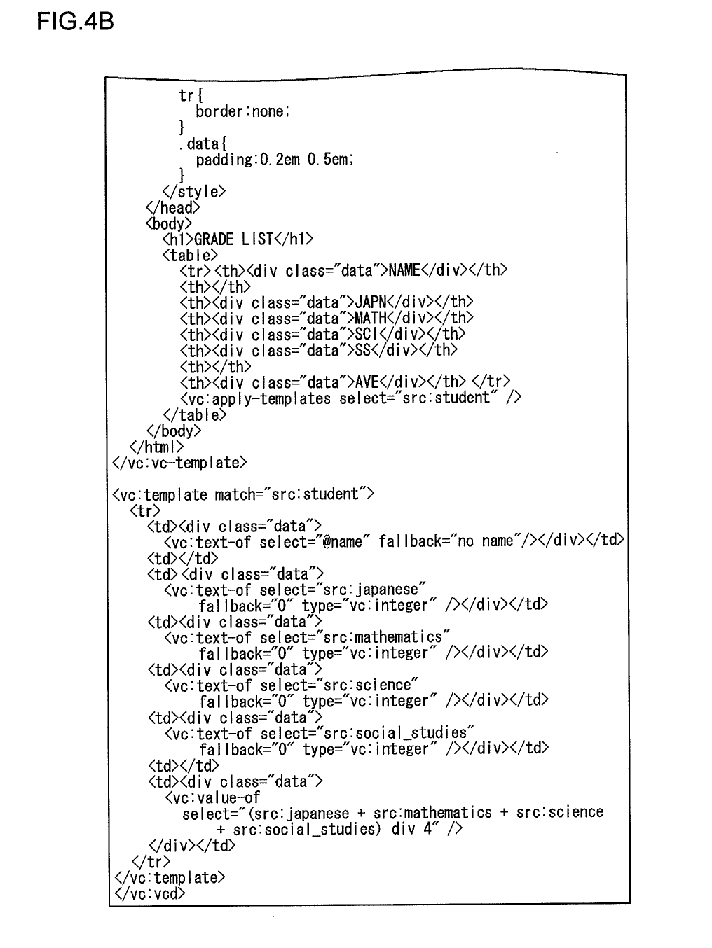

FIG. 4(a) and FIG. 4(b) illustrate an example of a definition file to map the XML document shown in FIG. 2 to the table shown in FIG. 3. This definition file is described in script language defined for use with definition files. In the definition file, definitions of commands and templates for display are described. In the example shown in FIG. 4(a) and FIG. 4(b), “add student” and “delete student” are defined as commands, and an operation of inserting a Node “student” into a source tree and an operation of deleting the Node “student” from the source tree, respectively, are associated with these commands. Furthermore, the definition file is described in the form of a template, which describes that a header, such as “name” and “japanese”, is displayed in the first row of a table and the contents of the Node “student” are displayed in the second and subsequent rows. In the template displaying the contents of the Node “student”, a term containing “text-of” indicates that editing is permitted, whereas a term containing “value-of” indicates that editing is not permitted. Among the rows where the contents of the Node “student” are displayed, an operation expression “(src:japanese+src:mathematics+scr:science+scr:social_studies) div 4” is described in the sixth row. This means that the average of the student's marks is displayed.

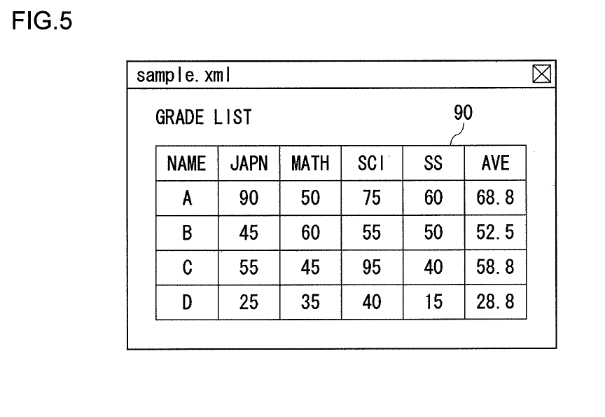

FIG. 5 shows an example of a display screen on which an XML document described in the marks managing vocabulary shown in FIG. 2 is displayed by mapping the XML document to HTML using the correspondence shown in FIG. 3. Displayed from left to right in each row of a table 90 are the names of each student, marks for Japanese, marks for mathematics, marks for science, marks for social studies and the averages thereof. The user can edit the XML document on this screen. For example, when the value in the second row and the third column is changed to “70”, the element value in the source tree corresponding to this Node, that is, the marks of student “B” for mathematics are changed to “70”. At this time, in order to have the destination tree follow the source tree, the VC unit 80 changes a relevant portion of the destination tree accordingly, so that HTML unit 50 updates the display based on the destination tree thus changed. Hence, the marks of student “B” for mathematics are changed to “70”, and the average is changed to “55” in the table on the screen.

On the screen as shown in FIG. 5, commands like “add student” and “delete student” are displayed in a menu as defined in the definition file shown in FIG. 4(a) and FIG. 4(b). When the user selects a command from among these commands, a Node “student” is added or deleted in the source tree. In this manner, with the document processing apparatus 20 according to the Prerequisite Technology, it is possible not only to edit the element values of components in a lower end of a hierarchical structure but also to edit the hierarchical structure. An edit function for editing such a tree structure may be presented to the user in the form of commands. Furthermore, a command to add or delete rows of a table may, for example, be linked to an operation of adding or deleting the Node “student”. A command to embed other vocabularies therein may be presented to the user. This table may be used as an input template, so that marks data for new students can be added in a fill-in-the-blank format. As described above, the VC function allows a document described in the marks managing vocabulary to be edited using the display/editing function of HTML unit 50.

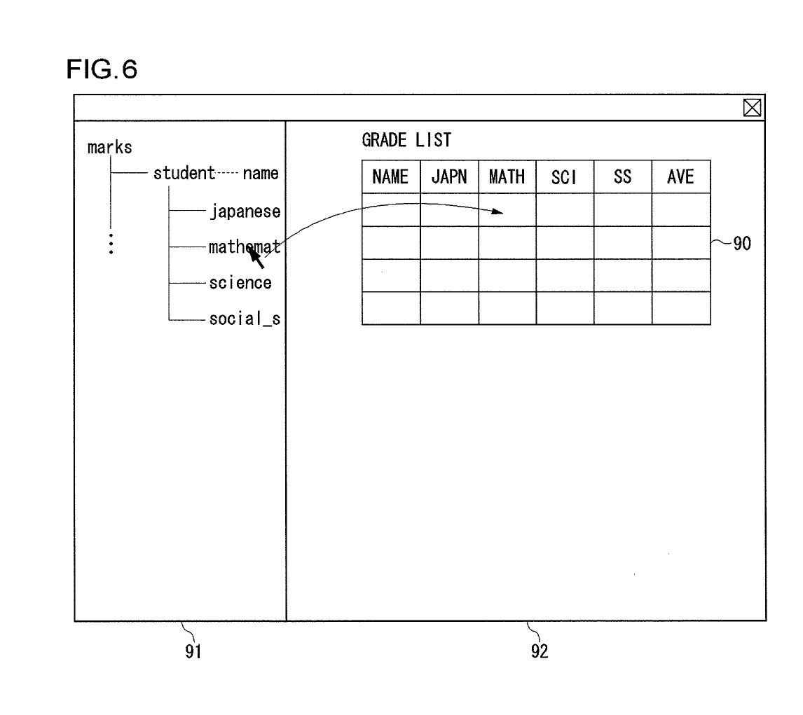

FIG. 6 shows an example of a graphical user interface, which the definition file generator 86 presents to the user, in command for the user to create a definition file. An XML document to be mapped is displayed in a tree in a left-hand area 91 of a screen. The screen layout of an XML document after mapping is displayed in a right-hand area 92 of the screen. This screen layout can be edited by HTML unit 50, and the user creates a screen layout for displaying documents in the right-hand area 92 of the screen. For example, a Node of the XML document which is to be mapped, which is displayed in the left-hand area 91 of the screen, is dragged and dropped into HTML screen layout in the right-hand area 92 of the screen using a pointing device such as a mouse, so that a connection between a Node at a mapping source and a Node at a mapping destination is specified. For example, when “mathematics,” which is a child element of the element “student,” is dropped to the intersection of the first row and the third column in a table 90 on HTML screen, a connection is established between the “mathematics” Node and a “TD” Node in the third column. Either editing or no editing can be specified for each Node. Moreover, the operation expression can be embedded in a display screen. When the screen editing is completed, the definition file generator 86 creates definition files, which describe connections between the screen layout and Nodes.

Viewers or editors which can handle major vocabularies such as XHTML, MathML and SVG have already been developed. However, it does not serve any practical purpose to develop dedicated viewers or editors for such documents described in the original vocabularies as shown in FIG. 2. If, however, the definition files for mapping to other vocabularies are created as mentioned above, the documents described in the original vocabularies can be displayed and/or edited utilizing the VC function without the need to develop a new viewer or editor.

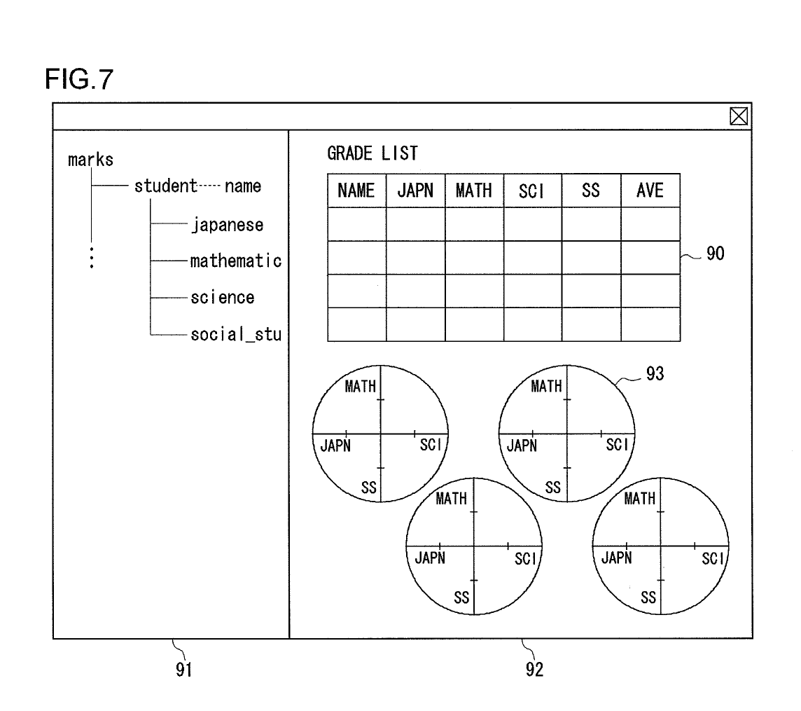

FIG. 7 shows another example of a screen layout created by the definition file generator 86. In the example shown in FIG. 7, a table 90 and circular graphs 93 are created on a screen for displaying XML documents described in the marks managing vocabulary. The circular graphs 93 are described in SVG. As will be discussed later, the document processing apparatus 20 according to the Prerequisite Technology can process a compound document described in the form of a single XML document according to a plurality of vocabularies. That is why the table 90 described in HTML and the circular graphs 93 described in SVG can be displayed on the same screen.

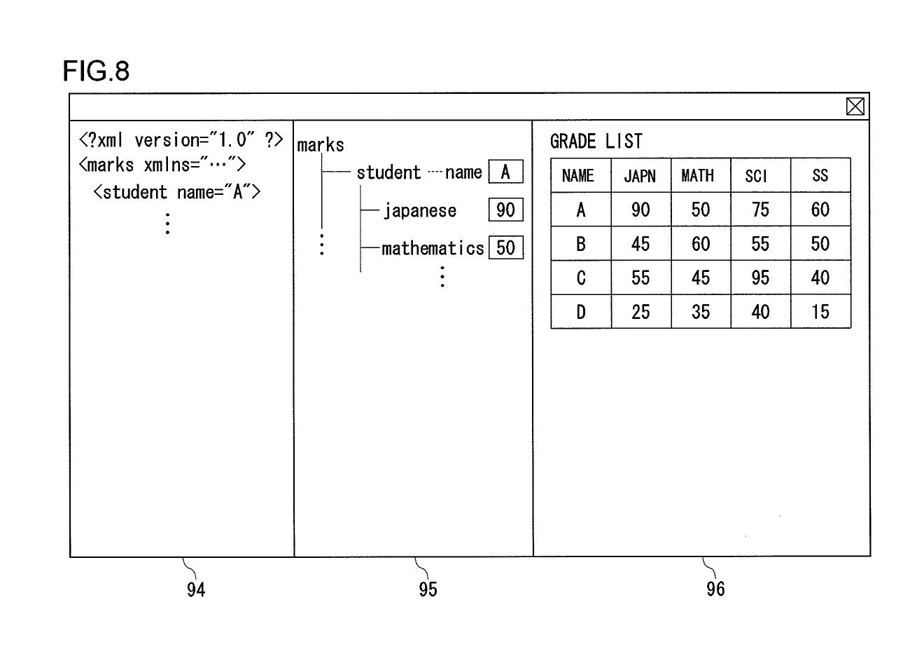

FIG. 8 shows an example of a display medium, which in a preferred but non-limiting embodiment is an edit screen, for XML documents processed by the document processing apparatus 20. In the example shown in FIG. 8, a single screen is partitioned into a plurality of areas and the XML document to be processed is displayed in a plurality of different display formats at the respective areas. The source of the document is displayed in an area 94, the tree structure of the document is displayed in an area 95, and the table shown in FIG. 5 and described in HTML is displayed in an area 96. The document can be edited in any of these areas, and when the user edits content in any of these areas, the source tree will be modified accordingly, and then each plug-in that handles the corresponding screen display updates the screen so as to effect the modification of the source tree. Specifically, display units of the plug-ins in charge of displaying the respective edit screens are registered in advance as listeners for mutation events that provide notice of a change in the source tree. When the source tree is modified by any of the plug-ins or the VC unit 80, all the display units, which are displaying the edit screen, receive the issued mutation event(s) and then update the screens. At this time, if the plug-in is executing the display through the VC function, the VC unit 80 modifies the destination tree following the modification of the source tree. Thereafter, the display unit of the plug-in modifies the screen by referring to the destination tree thus modified.

For example, when the source display and tree-view display are implemented by dedicated plug-ins, the source-display plug-in and the tree-display plug-in execute their respective displays by directly referring to the source tree without involving the destination tree. In this case, when the editing is done in any area of the screen, the source-display plug-in and the tree-display plug-in update the screen by referring to the modified source tree. Also, HTML unit 50 in charge of displaying the area 96 updates the screen by referring to the destination tree, which has been modified following the modification of the source tree.

The source display and the tree-view display can also be realized by utilizing the VC function. That is to say, an arrangement may be made in which the source and the tree structure are laid out in HTML, an XML document is mapped to HTML structure thus laid out, and HTML unit 50 displays the XML document thus mapped. In such an arrangement, three destination trees in the source format, the tree format and the table format are created. If the editing is carried out in any of the three areas on the screen, the VC unit 80 modifies the source tree and, thereafter, modifies the three destination trees in the source format, the tree format and the table format. Then, HTML unit 50 updates the three areas of the screen by referring to the three destination trees.

In this manner, a document is displayed on a single screen in a plurality of display formats, thus improving a user's convenience. For example, the user can display and edit a document in a visually easy-to-understand format using the table 90 or the like while understanding the hierarchical structure of the document by the source display or the tree display. In the above example, a single screen is partitioned into a plurality of display formats, and they are displayed simultaneously. Also, a single display format may be displayed on a single screen so that the display format can be switched according to the user's instructions. In this case, the main control unit 22 receives from the user a request for switching the display format and then instructs the respective plug-ins to switch the display.

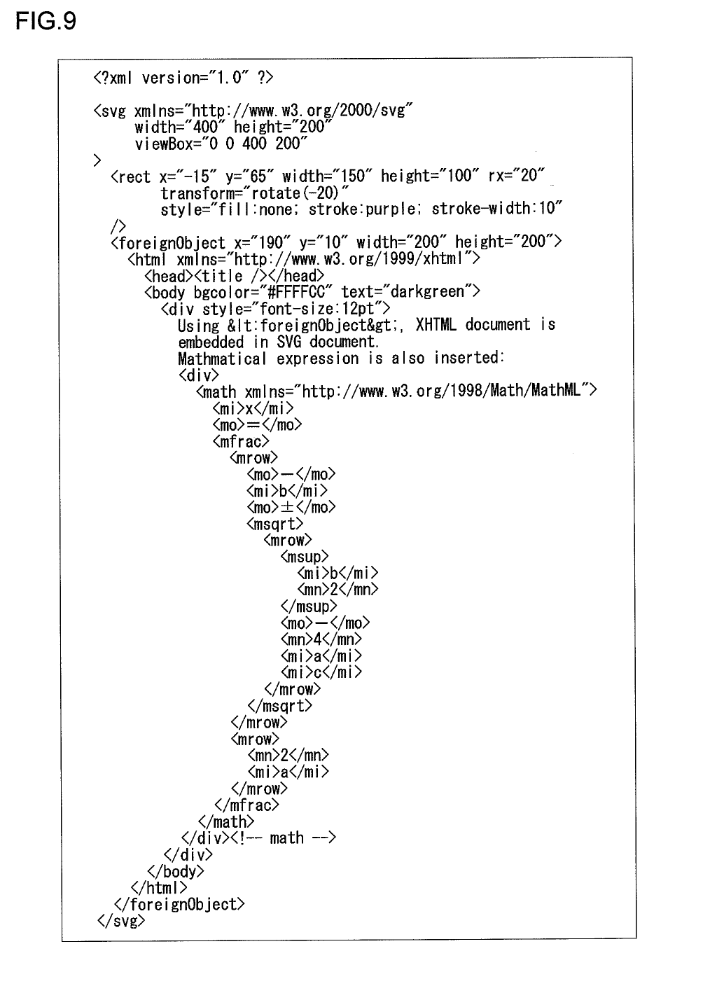

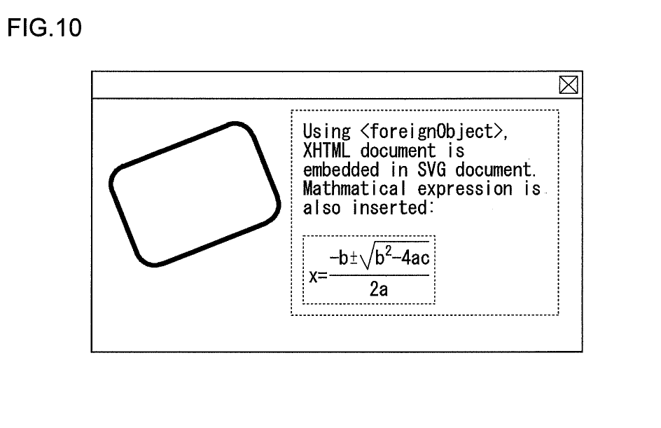

FIG. 9 illustrates another example of an XML document edited by the document processing apparatus 20. In the XML document shown in FIG. 9, an XHTML document is embedded in a “foreignObject” tag of an SVG document, and the XHTML document contains an equation described in MathML. In this case, the editing unit 24 assigns the rendering job to an appropriate display system by referring to the name space. In the example illustrated in FIG. 9, first, the editing unit 24 instructs the SVG unit 60 to render a rectangle, and then instructs HTML unit 50 to render the XHTML document. Furthermore, the editing unit 24 instructs a MathML unit (not shown) to render an equation. In this manner, the compound document containing a plurality of vocabularies is appropriately displayed. FIG. 10 illustrates the resulting display.

The displayed menu may be switched corresponding to the position of the cursor (carriage) during the editing of a document. That is, when the cursor lies in an area where an SVG document is displayed, the menu provided by the SVG unit 60, or a command set which is defined in the definition file for mapping the SVG document, is displayed. On the other hand, when the cursor lies in an area where the XHTML document is displayed, the menu provided by HTML unit 50, or a command set which is defined in the definition file for mapping HTML document, is displayed. Thus, an appropriate user interface can be presented according to the editing position.

In a case that there is neither a plug-in nor a mapping definition file suitable for any one of the vocabularies according to which the compound document has been described, a portion described in this vocabulary may be displayed in source or in tree format. In the conventional practice, when a compound document is to be opened where another document is embedded in a particular document, their contents cannot be displayed without the installation of an application to display the embedded document. According to the Prerequisite Technology, however, the XML documents, which are composed of text data, may be displayed in source or in tree format so that the contents of the documents can be ascertained. This is a characteristic of the text-based XML documents or the like.

Another advantageous aspect of the data being described in a text-based language, for example, is that, in a single compound document, a part of the compound document described in a given vocabulary can be used as reference data for another part of the same compound document described in a different vocabulary. Furthermore, when a search is made within the document, a string of characters embedded in a drawing, such as SVG, may also be search candidates.

In a document described in a particular vocabulary, tags belonging to other vocabularies may be used. Though such an XML document is generally not valid, it can be processed as a valid XML document as long as it is well-formed. In such a case, the tags thus inserted that belong to other vocabularies may be mapped using a definition file. For instance, tags such as “Important” and “Most Important” may be used so as to display a portion surrounding these tags in an emphasized manner, or may be sorted out in the command of importance.

When the user edits a document on an edit screen as shown in FIG. 10, a plug-in or a VC unit 80, which is in charge of processing the edited portion, modifies the source tree. A listener for mutation events can be registered for each Node in the source tree. Normally, a display unit of the plug-in or the VC unit 80 conforming to a vocabulary that belongs to each Node is registered as the listener. When the source tree is modified, the DOM provider 32 traces toward a higher hierarchy from the modified Node. If there is a registered listener, the DOM provider 32 issues a mutation event to the listener. For example, referring to the document shown in FIG. 9, if a Node which lies lower than the <html> Node is modified, the mutation event is notified to HTML unit 50, which is registered as a listener to the <html> Node. At the same time, the mutation event is also notified to the SVG unit 60, which is registered as a listener in an <svg> Node, which lies upper to the <html> Node. At this time, HTML unit 50 updates the display by referring to the modified source tree. Since the Nodes belonging to the vocabulary of the SVG unit 60 itself are not modified, the SVG unit 60 may disregard the mutation event.

Depending on the contents of the editing, modification of the display by HTML unit 50 may change the overall layout. In such a case, the layout is updated by a screen layout management mechanism, e.g., the plug-in that handles the display of the highest Node, in increments of display regions which are displayed according to the respective plug-ins. For example, in a case of expanding a display region managed by HTML unit 50, first, HTML unit 50 renders a part managed by HTML unit 50 itself, and determines the size of the display region. Then, the size of the display area is notified to the component that manages the screen layout so as to request the updating of the layout. Upon receipt of this notice, the component that manages the screen layout rebuilds the layout of the display area for each plug-in. Accordingly, the display of the edited portion is appropriately updated and the overall screen layout is updated.

Then, further detailed description will be made regarding functions and components for providing the document processing 20 according to the Prerequisite Technology. In the following description, English terms are used for the class names and so forth.

A. Outline

The advent of the Internet has resulted in a nearly exponential increase in the number of documents processed and managed by users. The Web (World Wide Web), which serves as the core of the Internet, provides a massive storage capacity for storing such document data. The Web also provides an information search system for such documents, in addition to the function of storing the documents. In general, such a document is described in a markup language. HTML (HyperText Markup Language) is an example of a popular basic markup language. Such a document includes links, each of which links the document to another document stored at another position on the Web. XML (eXtensible Markup Language) is a popular further improved markup language. Simple browsers which allow the user to access and browse such Web documents have been developed using object-oriented programming languages such as Java (trademark).

In general, documents described in markup languages are represented in a browser or other applications in the form of a tree data structure. This structure corresponds to a tree structure obtained as a result of parsing a document. The DOM (Document Object Model) is a well-known tree-based data structure model, which is used for representing and processing a document. The DOM provides a standard object set for representing documents, examples of which include an HTML document, an XML document, etc. The DOM includes two basic components, i.e., a standard model which shows how the objects that represent the respective components included in a document are connected to one another, and a standard interface which allows the user to access and operate each object.

Application developers can support the DOM as an interface for handling their own data structure and API (Application Program Interface). On the other hand, application providers who create documents can use the standard interface of the DOM, instead of using the DOM as an interface for handling their own API. The capacity of the DOM to provide such a standard interface has been effective in promoting document sharing in various environments, particularly on the Web. Several versions of the DOM have been defined, which are used in different environments and applications.

A DOM tree is a hierarchical representation of the structure of a document, which is based upon the content of a corresponding DOM. A DOM tree includes a “root”, and one or more “Nodes” branching from the root. In some cases, an entire document is represented by a root alone. An intermediate Node can represent an element such as a table, or a row or a column of the table, for example. A “leaf” of a DOM tree generally represents data which cannot be further parsed, such as text data, image data, etc. Each of the Nodes of the DOM tree may be associated with an attribute that specifies a parameter of the element represented by the Node, such as a font, size, color, indent, etc.

HTML is a language which is generally used for creating a document. However, HTML is a language that provides formatting and layout capabilities, and it is not meant to be used as a data description language. The Node of the DOM tree for representing an HTML document is defined beforehand as an HTML formatting tag, and in general, HTML does not provide detailed data description and data tagging/labeling functions. This leads to a difficulty in providing a query format for the data included in an HTML document.

The goal of network designers is to provide a software application which allows the user to make a query for and to process a document provided on the Web. Such a software application should allow the user to make a query for and to process a document, regardless of the display method, as long as the document is described in a hierarchically structured language. A markup language such as XML (eXtensible Markup Language) provides such functions.

Unlike HTML, XML has a well-known advantage of allowing the document designer to label each data element using a tag which can be defined by the document designer as desired. Such data elements can form a hierarchical structure. Furthermore, an XML document can include a document type definition that specifies a “grammar” which specifies the tags used in the document and the relations between the tags. Also, in order to define the display method of such a structured XML document, CSS (Cascading Style Sheets) or XSL (XML Style Language) is used. Additional information with respect to the features of the DOM, HTML, XML, CSS, XSL, and the related languages can be acquired via the Web, for example, from “http://www.w3.org/TR/”.

XPath provides common syntax and semantics which allow the position of a portion of an XML document to be specified. Examples of such functions include a function of traversing a DOM tree that corresponds to an XML document. This provides basic functions for operating character strings, values, and Boolean variables, which are related to the function of displaying an XML document in various manners. XPath does not provide a syntax for how the XML document is displayed, e.g., a grammar which handles a document in the form of text in increments of lines or characters. Instead of such a syntax, XPath handles a document in the form of an abstract and logical structure. The use of XPath allows the user to specify a position in an XML document via the hierarchical structure of a DOM tree of the XML document, for example. Also, XPath has been designed so as to allow the user to test whether or not the Nodes included in a DOM tree match a given pattern. Detailed description of XPath can be obtained from http://www.w3.org/TR/xpath.

There is a demand for an effective document processing system based upon the known features and advantages of XML, which provides a user-friendly interface which handles a document described in a markup language (e.g., XML), and which allows the user to create and modify such a document.

Some of the system components as described here will be described in a well-known GUI (Graphical User Interface) paradigm which is called the MVC (Model-View-Controller) paradigm. The MVC paradigm divides a part of an application or an interface of an application into three parts, i.e., “model”, “view”, and “controller”. In the GUI field, the MVC paradigm has been developed primarily for assigning the roles of “input”, “processing”, and “output”.

[input] R [processing] R [output]

[controller] R [model] R [view]

The MVC paradigm separately handles modeling of external data, visual feedback for the user, and input from the user, using a model object (M), a view object (V), and a controller object (C). The controller object analyzes the input from the user input via a mouse and a keyboard, and maps such user actions to a command to be transmitted to the model object and/or the view object. The model object operates so as to manage one or more data elements. Furthermore, the model object makes a response to a query with respect to the state of the data elements, and operates in response to an instruction to change the state of the data elements. The view object has a function of presenting data to the user in the form of a combination of graphics and text.

B. Overall Configuration of the Document Processing System

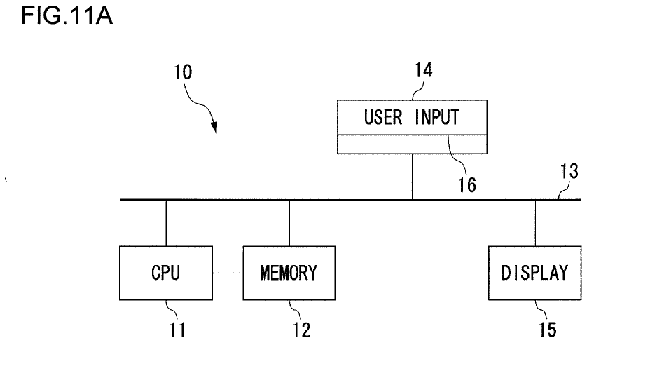

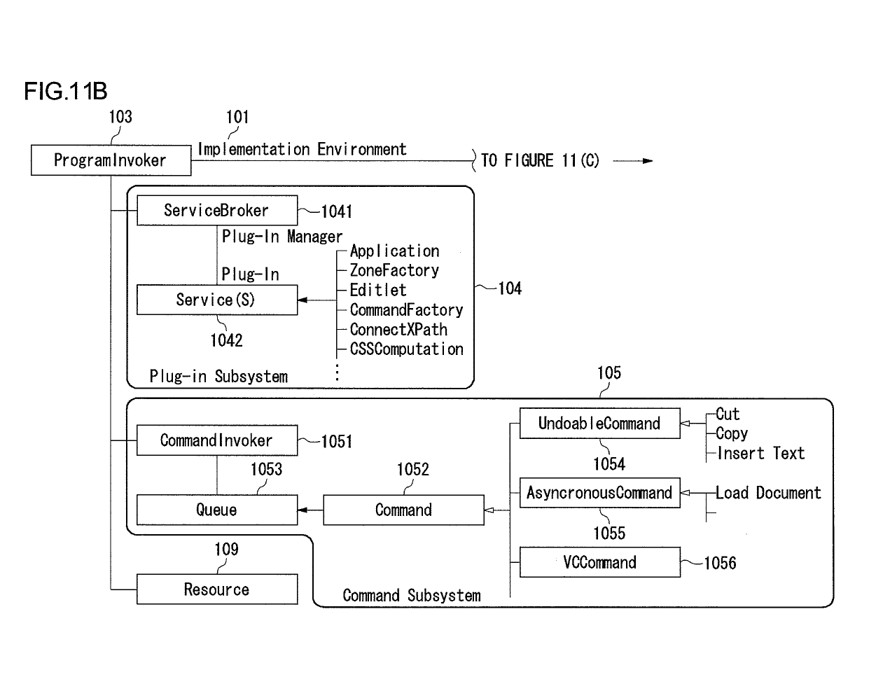

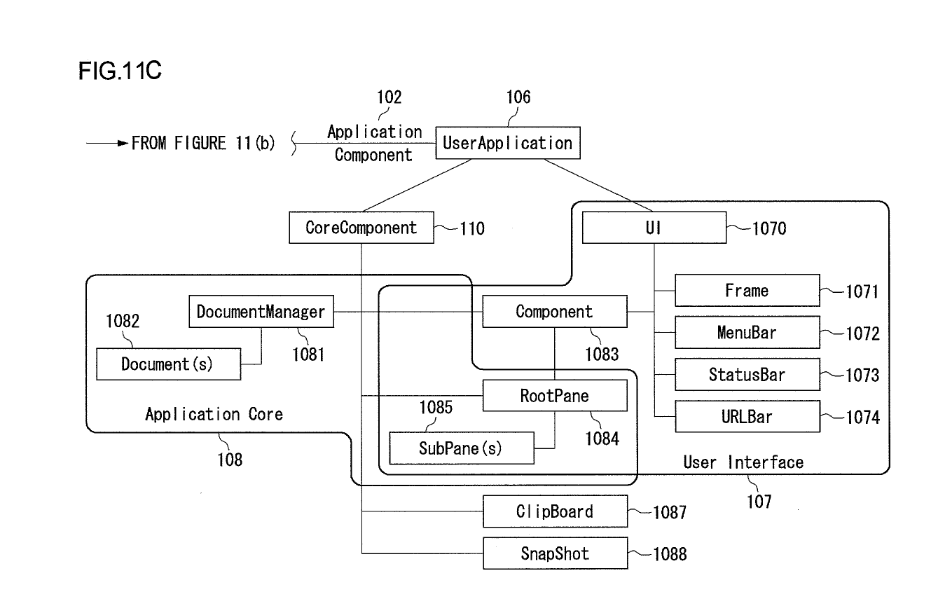

In order to make clear an embodiment of the document processing system, description will be made with reference to FIGS. 11 through 29.

FIG. 11(a) shows an example of a configuration comprising components that provide the basic functions of a kind of document processing system according to a conventional technique as will be mentioned later. A configuration 10 includes a processor in the form of a CPU or a microprocessor 11 connected to memory 12 via a communication path 13. The memory 12 may be provided in the form of any kind of ROM and/or RAM that is currently available or that may be available in the future. In a typical case, the communication path 13 is provided in the form of a bus. An input/output interface 16 for user input devices such as a mouse, a keyboard, a speech recognition system, etc., and a display device 15 (or other user interfaces) is connected to the bus that provides communication with the processor 11 and the memory 12. Such a configuration may be provided in the form of a standalone device. Also, such a configuration may be provided in the form of a network which includes multiple terminals and one or more servers connected to one another. Also, such a configuration may be provided in any known form. The present invention is not restricted to a particular layout of the components, a particular architecture, e.g., a centralized architecture or a distributed architecture, or a particular one of various methods of communication between the components.

Furthermore, description will be made below regarding the present system and the embodiment regarding an arrangement including several components and sub-components that provide various functions. In order to provide desired functions, the components and the sub-components can be realized by hardware alone, or by software alone, in addition to various combinations of hardware and software. Furthermore, the hardware, the software, and the various combinations thereof can be realized by general purpose hardware, dedicated hardware, or various combinations of general purpose and dedicated hardware. Accordingly, the configuration of the component or the sub-component includes a general purpose or dedicated computation device for executing predetermined software that provides a function required for the component or the sub-component.

FIG. 11(b) is a block diagram which shows an overall configuration of an example of the document processing system. Such a document processing system allows a document to be created and edited. Such a document may be described in a desired language that has the functions required of a markup language, such as XML etc. Note that some terms and titles will be defined here for convenience of explanation. However, the general scope of the disclosure according to the present invention is not intended to be restricted by such terms and titles thus defined here.

The document processing system can be classified into two basic configurations. A first configuration is an “execution environment” 101 which provides an environment that allows the document processing system to operate. For example, the execution environment provides basic utilities and functions that support both the system and the user during the processing and management of a document. A second configuration is an “application” 102 that comprises applications that run under an execution environment. These applications include the documents themselves and various representations of the documents.

1. Execution Environment

The key component of the execution environment 101 is the ProgramInvoker (program invoking unit) 103. The ProgramInvoker 103 is a basic program, which is accessed in order to start up the document processing system. For example, upon the user logging on and starting up the document processing system, the ProgramInvoker 103 is executed. The ProgramInvoker 103 has: a function of reading out and executing a function added to the document processing system in the form of a plug-in; a function of starting up and executing an application; and a function of reading out the properties related to a document, for example. However, the functions of the ProgramInvoker 103 are not restricted to these functions. Upon the user giving an instruction to start up an application to be executed under the execution environment, the ProgramInvoker 103 finds and starts up the application, thereby executing the application.

Also, several components are attached to the ProgramInvoker 103, examples of which include a plug-in sub-system 104, a command sub-system 105, and a resource module 109. Detailed description will be made below regarding the configurations of such components.

a) Plug-In Sub-System

The plug-in sub-system is used as a highly flexible and efficient configuration which allows an additional function to be added to the document processing system. Also, the plug-in sub-system 104 can be used for modifying or deleting functions included in the document processing system. Also, various kinds of functions can be added or modified using the plug-in sub-system. For example, the plug-in sub-system 104 allows an Editlet (editing unit) to be added, which supports functions of allowing the user to edit via the screen. Also, the Editlet plug-in supports the functions of allowing the user to edit a vocabulary added to the system.

The plug-in sub-system 104 includes a ServiceBroker (service broker unit) 1041. The ServiceBroker 1041 manages a plug-in added to the document processing system, thereby mediating between the service thus added and the document processing system.

Each of the desired functions is added in the form of a Service 1042. Examples of the available types of Services 1042 include: an Application Service; a ZoneFactory (zone creating unit) Service; an Editlet (editing unit) Service; a CommandFactory (command creating unit) Service; a ConnectXPath (XPath management unit) Service; a CSSComputation (CSS calculation unit) Service; etc. However, the Service 1042 is not restricted to such services. Detailed description will be made below regarding these Services, and regarding the relation between these Services and other components of the system, in order to facilitate understanding of the document processing system.

Description will be made below regarding the relation between a plug-in and a Service. The plug-in is a unit capable of including one or more ServiceProviders (service providing units). Each ServiceProvider has one or more classes for corresponding Services. For example, upon using a plug-in having an appropriate software application, one or more Services are added to the system, thereby adding the corresponding functions to the system.

b) Command Sub-System

The command sub-system 105 is used for executing a command relating to the processing of a document. The command sub-system 105 allows the user to execute the processing of the document by executing a series of commands. For example, the command sub-system 105 allows the user to edit an XML DOM tree that corresponds to an XML document stored in the document processing system, and to process the XML document, by issuing a command. These commands may be input by key-strokes, mouse-clicks, or actions via other valid user interfaces. In some cases, when a single command is input, one or more sub-commands are executed. In such a case, these sub-commands are wrapped in a single command, and the sub-commands are consecutively executed. For example, let us consider a case in which the user has given an instruction to replace an incorrect word with a correct word. In this case, a first sub-command is an instruction to detect an incorrect word in the document. Then, a second sub-command is an instruction to delete the incorrect word. Finally, a third function is an instruction to insert a correct word. These three sub-commands may be wrapped in a single command.

Each command may have a corresponding function, e.g., an “undo” function described later in detail. Such a function may also be assigned to several basic classes used for creating an object.

The key component of the command sub-system 105 is a CommandInvoker (command invoking unit) 1051 which operates so as to allow the user to selectively input and execute the commands. FIG. 11(b) shows an arrangement having a single CommandInvoker. Also, one or more CommandInvokers may be used. Also, one or more commands may be executed at the same time. The CommandInvoker 1051 holds the functions and classes required for executing the command. In the operation, the Command 1052 is loaded in a Queue 1053. Then, the CommandInvoker 1051 creates a command thread for executing the commands in sequence. In a case that no Command is currently being executed by the CommandInvoker, the Command 1052 provided to be executed by the CommandInvoker 1051 is executed. In a case that a command is currently being executed by the CommandInvoker, the new Command is placed at the end of the Queue 1053. However, each CommandInvoker 1051 executes only a single command at a time. In a case of failure in executing the Command thus specified, the CommandInvoker 1051 performs exception handling.

Examples of the types of Commands executed by the CommandInvoker 1051 include: an UndoableCommand (undoable command) 1054; an AsynchronousCommand (asynchronous command) 1055; and a VCCommand (VC command) 1056. However, the types of commands are not restricted to those examples. The UndoableCommand 1054 is a command which can be undone according to an instruction from the user. Examples of UndoableCommands include a deletion command, a copy command, a text insertion command, etc. Let us consider a case in which, in the course of operation, the user has selected a part of a document, following which the deletion command is applied to the part thus selected. In this case, the corresponding UndoableCommand allows the deleted part to be restored to the state that it was in before the part was deleted.

The VCCommand 1056 is stored in a Vocabulary Connection Descriptor (VCD) script file. The VCCommand 1056 is a user specified Command defined by a programmer. Such a Command may be a combination of more abstract Commands, e.g., a Command for adding an XML fragment, a Command for deleting an XML fragment, a Command for setting an attribute, etc. In particular, such Commands are provided with document editing in mind.

The AsynchronousCommand 1055 is a command primarily provided for the system, such as a command for loading a document, a command for storing a document, etc. AsynchronousCommands 1055 are executed in an asynchronous manner, independently of UndoableCommands and VCCommands. Note that the AsynchronousCommand does not belong to the class of undoable commands (it is not an UndoableCommand). Accordingly, an AsynchronousCommand cannot be undone.

c) Resource

The Resource 109 is an object that provides several functions to various classes. Examples of such system Resources include string resources, icon resources, and default key bind resources.

2. Application Component

The application component 102, which is the second principal component of the document processing system, is executed under the execution environment 101. The application component 102 includes actual documents and various kinds of logical and physical representations of the documents included in the system. Furthermore, the application component 102 includes the configuration of the system used for management of the documents. The application component 102 further includes a UserApplication (user application) 106, an application core 108, a user interface 107, and a CoreComponent (core component) 110.

a) User Application

The UserApplication 106 is loaded in the system along with the ProgramInvoker 103. The UserApplication 106 serves as a binding agent that connects a document, the various representations of the document, and the user interface required for communicating with the document. For example, let us consider a case in which the user creates a document set which is a part of a project. Upon loading the document set, an appropriate representation of the document is created. The user interface function is added as a part of the UserApplication 106. In other words, with regard to a document that forms a part of a project, the UserApplication 106 holds both the representation of the document that allows the user to communicate with the document, and various other document conditions. Once the UserApplication 106 has been created, such an arrangement allows the user to load the UserApplication 106 under the execution environment in a simple manner every time there is a need to communicate with a document that forms a part of a project.

b) Core Component

The CoreComponent 110 provides a method which allows a document to be shared over multiple panes. As described later in detail, the Pane displays a DOM tree, and provides a physical screen layout. For example, a physical screen is formed of multiple Panes within a screen, each of which displays a corresponding part of the information. With such an arrangement, a document displayed on the screen for the user can be displayed in one or more Panes. Also, two different documents may be displayed on the screen in two different Panes.

As shown in FIG. 11(c), the physical layout of the screen is provided in a tree form. The Pane can be a RootPane (root pane) 1084. Also, the Pane can be a SubPane (sub-pane) 1085. The RootPane 1084 is a Pane which is positioned at the root of a Pane tree. The SubPanes 1085 are other Panes that are distinct from the RootPane 1084.

The CoreComponent 110 provides a font, and serves as a source that provides multiple functional operations for a document. Examples of the tasks executed by the CoreComponent 110 include movement of a mouse cursor across the multiple Panes. Other examples of the tasks thus executed include a task whereby a part of the document displayed on a Pane is marked, and the part thus selected is duplicated on another Pane.

c) Application Core

As described above, the application component 102 has a structure that comprises documents to be processed and managed by the system. Furthermore, the application component 102 includes various kinds of logical and physical representations of the documents stored in the system. The application core 108 is a component of the application component 102. The application core 108 provides a function of holding an actual document along with all the data sets included in the document. The application core 108 includes a DocumentManager (document manager, document managing unit) 1081 and a Document (document) 1082 itself.

Detailed description will be made regarding various embodiments of the DocumentManager 1081. The DocumentManager 1081 manages the Document 1082. The DocumentManager 1081 is connected to the RootPane 1085, the SubPane 1085, a ClipBoard (clipboard) utility 1087, and a SnapShot (snapshot) utility 1088. The ClipBoard utility 1087 provides a method for holding a part of the document which is selected by the user as a part to be added to the clipboard. For example, let us consider a case in which the user deletes a part of a document, and stores the part thus deleted in a new document as a reference document. In this case, the part thus deleted is added to the ClipBoard.

Next, description will also be made regarding the SnapShot utility 1088. The SnapShot utility 1088 allows the system to store the current state of an application before the state of the application changes from one particular state to another state.

d) User Interface

The user interface 107 is another component of the application component 102, which provides a method that allows the user to physically communicate with the system. Specifically, the user interface allows the user to upload, delete, edit, and manage a document. The user interface includes a Frame (frame) 1071, a MenuBar (menu bar) 1072, a StatusBar (status bar) 1073, and a URLBar (URL bar) 1074.

The Frame 1071 serves as an active region of a physical screen, as is generally known. The Menubar 1072 is a screen region including a menu that provides selections to the user. The StatusBar 1073 is a screen region that displays the status of the application which is being executed. The URLBar 1074 provides a region which allows the user to input a URL address for Internet navigation.

C. Document Management and Corresponding Data Structure

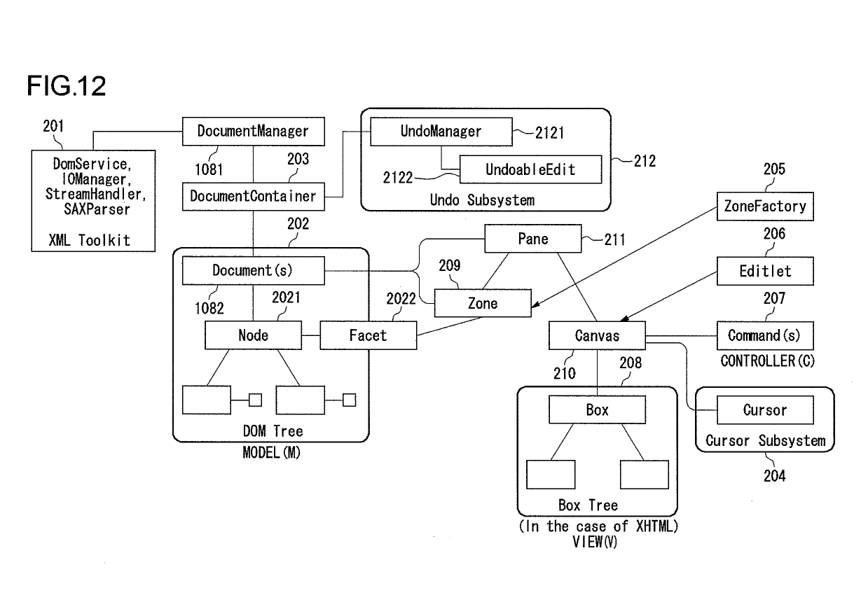

FIG. 12 shows a configuration of the DocumentManager 1081 in detail. The DocumentManager 1081 includes a data structure and components used for representing a document in the document processing system. Description will be made regarding such components in this sub-section using the MVC paradigm for convenience of explanation.

The DocumentManager 1081 includes a DocumentContainer (document container) 203 which holds all the documents stored in the document processing system, and which serves as a host machine. A tool kit 201 attached to the DocumentManager 1081 provides various tools used by the DocumentManager 1081. For example, the tool kit 201 provides a DomService (DOM service) which provides all the functions required for creating, holding, and managing a DOM that corresponds to a document. Also, the tool kit 201 provides an IOManager (input/output management unit) which is another tool for managing the input to/output from the system. Also, a StreamHandler (stream handler) is a tool for handling uploading a document in the form of a bit stream. The tool kit 201 includes such tools in the form of components, which are not shown in the drawings in particular, and are not denoted by reference numerals.

With the system represented using the MVC paradigm, the model (M) includes a DOM tree model 202 of a document. As described above, each of all the documents is represented by the document processing system in the form of a DOM tree. Also, the document forms a part of the DocumentContainer 203.

1. DOM Model and Zone

The DOM tree which represents a document has a tree structure having Nodes (Nodes) 2021. A Zone (zone) 209, which is a subset of the DOM tree, includes a region that corresponds to one or more Nodes within the DOM tree. For example, a part of a document can be displayed on a screen. In this case, the part of the document that is visually output is displayed using the Zone 209. The Zone is created, handled, and processed using a plug-in which is so-called ZoneFactory (Zone Factory=Zone creating unit) 205. While the Zone represents a part of the DOM, the Zone can use one or more “namespaces”. It is well known that a namespace is a set that consists of unique names, each of which differs from every other name in the namespace. In other words, the namespace does not include the same names repeated.

2. Facets and the Relation Between Facets and Zones

A Facet 2022 is another component included in the model (M) component of the MVC paradigm. The Facet is used for editing the Node in the Zone. The Facet 2022 allows the user to access the DOM using a procedure that can be executed without affecting the content of the Zone. As described below, such a procedure executes an important and useful operation with respect to the Node.

Each Node has a corresponding Facet. With such an arrangement, the facet is used for executing the operation instead of directly operating the Node in the DOM, thereby maintaining the integrity of the DOM. On the other hand, let us consider an arrangement in which an operation is performed directly on the Node. With such an arrangement, multiple plug-ins can change the DOM at the same time, leading to a problem that the integrity of the DOM cannot be maintained.

The DOM standard stipulated by the World Wide Web Consortium (W3C) defines a standard interface for operating a Node. In practice, unique operations particular to each vocabulary or each Node are required. Accordingly, such unique operations are preferably provided in the form of an API. The document processing system provides such an API particular to each Node in the form of a Facet which is attached to the Node. Such an arrangement allows a useful API to be attached to the DOM according to the DOM standard. Furthermore, with such an arrangement, after a standard DOM has been installed, unique APIs are attached to the DOM, instead of installing a unique DOM for each vocabulary. This allows various kinds of vocabularies to be uniformly handled. Furthermore, such an arrangement allows the user to properly process a document described using a desired combination of multiple vocabularies.

Each vocabulary is a set of tags (e.g., XML tags), which belong to a corresponding namespace. As described above, each namespace has a set of unique names (in this case, tags). Each vocabulary is handled as a sub-tree of the DOM tree which represents an XML document. The sub-tree includes the Zone. In particular cases, the boundary between the tag sets is defined by the Zone. The Zone 209 is created using a Service which is called a ZoneFactory 205. As described above, the Zone 209 is an internal representation of a part of the DOM tree which represents a document. In order to provide a method that allows the user to access a part of such a document, the system requires a logical representation of the DOM tree. The logical representation of the DOM allows the computer to be informed of how the document is logically represented on a screen. A Canvas (canvas) 210 is a Service that operates so as to provide a logical layout that corresponds to the Zone.

On the other hand, a Pane 211 is a physical screen layout that corresponds to a logical layout provided by the Canvas 210. In practice, the user views only a rendering of the document, through text or images displayed on a screen. Accordingly, there is a need to use a process for drawing text and images on a screen to display the document on a screen. With such an arrangement, the document is displayed on a screen by the Canvas 210 based upon the physical layout provided from the Pane 211.

The Canvas 210 that corresponds to the Zone 209 is created using an Editlet 206. The DOM of the document is edited using the Editlet 206 and the Canvas 210. In order to maintain the integrity of the original document, the Editlet 206 and the Canvas 210 use the Facet that corresponds to one or more Nodes included in the Zone 209. The Facet is operated using a Command 207.

In general, the user communicates with a screen by moving a cursor on a screen or typing a command. The Canvas 210, which provides a logical layout on a screen, allows the user to input such cursor operations. The Canvas 210 instructs the Facet to execute a corresponding action. With such a relation, the cursor sub-system 204 serves as a controller (C) according to the MVC paradigm with respect to the DocumentManager 1081. The Canvas 210 also provides a task for handling an event. Examples of such events handled by the canvas 210 include: a mouse click event; a focus movement event; and a similar action event occurring in response to the user operation.

3. Outline of the Relation Between Zone, Facet, Canvas, and Pane.

The document in the document processing system can be described from at least four points of view. That is to say, it can be seen as: 1) a data structure for maintaining the content and structure of a document in the document processing system, 2) means by which the user can edit the content of the document while maintaining the integrity of the document, 3) a logical layout of the document on a screen, and 4) a physical layout of the document on the screen. The components of the document processing system that correspond to the aforementioned four points of view are the Zone, Facet, Canvas, and Pane, respectively.

4. Undo Sub-System

As described above, all modifications made to the document (e.g., document editing procedures) are preferably undoable. For example, let us consider a case in which the user executes an editing operation, and then determines that the modification thus made to the document should be undone. Referring to FIG. 12, the undo subsystem 212 provides an undo component of a document management unit. With such an arrangement, an UndoManager (undo manager=undo management unit) 2121 holds all the undoable operations for the document which the user can select to be undone.

Let us consider a case in which the user executes a command for replacing a word in a document by another word, following which the user determines that, on reflection, the replacement of the word thus effected should be undone. The undo sub-system supports such an operation. The UndoManager 2121 holds such an operation of an UndoableEdit (undoable edit) 2122.

5. Cursor Sub-System

As described above, the controller unit of the MVC may include the cursor sub-system 204. The cursor sub-system 204 receives the input from the user. In general, such an input provides command input and/or edit operation. Accordingly, with respect to the DocumentManager 1081, the cursor sub-system 204 serves as the controller (C) component according to the MVC paradigm.

6. View

As described above, the Canvas 210 represents the logical layout of a document to be displayed on a screen. In a case that the document is an XHTML document, the Canvas 210 may include a box tree 208 that provides a logical representation of a document, which indicates how the document is displayed on a screen. With respect to the DocumentManager 1081, the box tree 208 may be included in the view (V) component according to the MVC paradigm.

D. Vocabulary Connection

The important feature of the document processing system is that the document processing system provides an environment which allows the user to handle an XML document via other representations to which the document has been mapped. With such an environment, upon the user editing a representation to which the source XML document has been mapped, the source XML document is modified according to the edit operation while maintaining the integrity of the XML document.

A document described in a markup language, e.g., an XML document is created based upon a vocabulary defined by a document type definition. The vocabulary is a set of tags. The vocabulary can be defined as desired. This allows a limitless number of vocabularies to be created. It does not serve any practical purpose to provide dedicated viewer/editor environments for such a limitless number of vocabularies. The vocabulary connection provides a method for solving this problem.

For example, a document can be described in two or more markup languages. Specific examples of such markup languages used for describing a document include: XHTML (eXtensible HyperText Markup Language), SVG (Scalable Vector Graphics), MathML (Mathematical Markup Language), and other markup languages. In other words, such a markup language can be handled in the same way as is the vocabulary or the tag set in XML.

A vocabulary is processed using a vocabulary plug-in. In a case that the document has been described in a vocabulary for which there is no available plug-in in the document processing system, the document is mapped to a document described in another vocabulary for which a plug-in is available, thereby displaying the document. Such a function enables a document to be properly displayed even if the document has been described in a vocabulary for which there is no available plug-in.

The vocabulary connection has a function of acquiring a definition file, and a function of mapping from one vocabulary to another different vocabulary based upon the definition file thus acquired. With such an arrangement, a document described in one vocabulary can be mapped to a document described in another vocabulary. As described above, the vocabulary connection maps a document described in one vocabulary to another document described in another vocabulary for which there is a corresponding display/editing plug-in, thereby allowing the user to display and edit the document.

As described above, in general, each document is described by the document processing system in the form of a DOM tree having multiple Nodes. The “definition file” describes the relations among the different Nodes. Furthermore, the definition file specifies whether or not the element values and the attribute values can be edited for each Node. Also, the definition file may specify an expression using the element values and the attribute values of the Nodes.

Using the mapping function by applying the definition file, a destination DOM tree can be created. As described above, the relation between the source DOM tree and the destination DOM tree is created and held. The vocabulary connection monitors the relation between the source DOM tree and the destination DOM tree. Upon reception of an editing instruction from the user, the vocabulary connection modifies the corresponding Node included in the source DOM tree. Subsequently, a “mutation event” is issued, which gives notice that the source DOM tree has been modified. Then, the destination DOM tree is modified in response to the mutation event.

The use of the vocabulary connection allows a relatively minor vocabulary used by a small number of users to be converted into another major vocabulary. Thus, such an arrangement provides a desirable editing environment, which allows a document to be properly displayed even if the document is described in a minor vocabulary used by a small number of users.

As described above, the vocabulary connection sub-system which is a part of the document processing system provides a function that allows a document to be represented in multiple different ways.

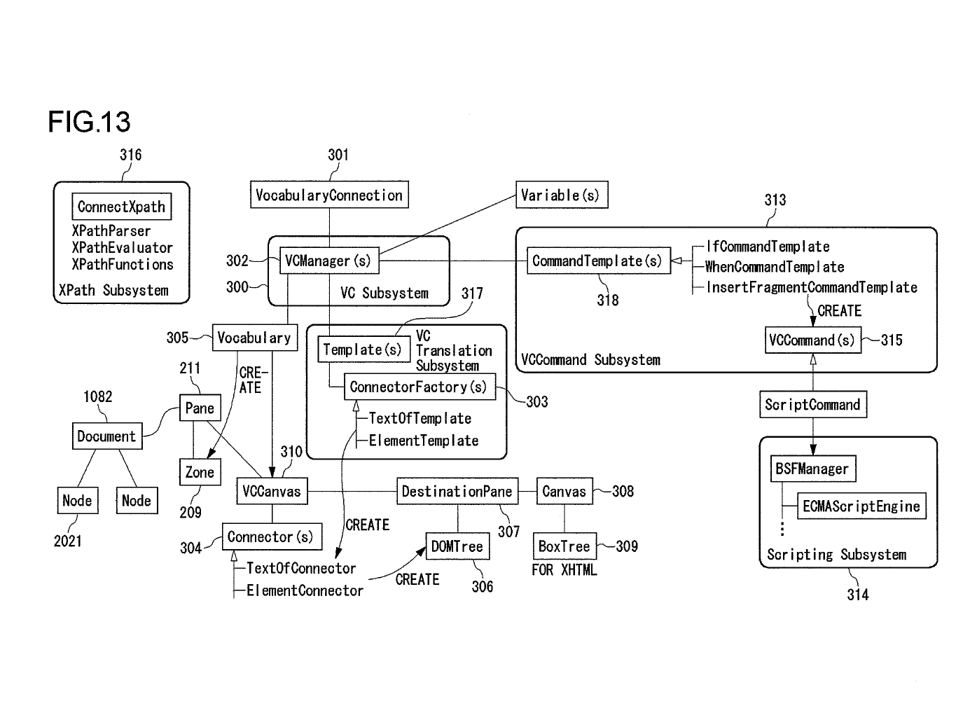

FIG. 13 shows a vocabulary connection (VC) sub-system 300. The VC sub-system 300 provides a method for representing a document in two different ways while maintaining the integrity of the source document. For example, a single document may be represented in two different ways using two different vocabularies. Also, one representation may be a source DOM tree, and the other representation may be a destination DOM tree, as described above.

1. Vocabulary Connection Sub-System

The functions of the vocabulary connection sub-system 300 are provided to the document processing system using a plug-in which is called a VocabularyConnection 301. With such an arrangement, a corresponding plug-in is requested for each Vocabulary 305 used for representing the document. For example, let us consider a case in which a part of the document is described in HTML, and the other part is described in SVG. In this case, the vocabulary plug-in that corresponds to HTML and the vocabulary plug-in that corresponds to SVG are requested.

The VocabularyConnection plug-in 301 creates a proper VCCanvas (vocabulary connection canvas) 310 that corresponds to a document described in a properVocabulary 305 for the Zone 209 or the Pane 211. Using the VocabularyConnection 301, a modification made to the Zone 209 within the source DOM tree is transmitted to the corresponding Zone within another DOM tree 306 according to a conversion rule. The conversion rule is described in the form of a vocabulary connection descriptor (VCD). Furthermore, a corresponding VCManager (vocabulary connection manager) 302 is created for each VCD file that corresponds to such a conversion between the source DOM and the destination DOM.

2. Connector

A Connector 304 connects the source Node included within the source DOM tree and the destination Node included within the destination DOM tree. The Connector 304 operates so as to monitor modifications (changes) made to the source Node included within the source DOM tree and the source document that corresponds to the source Node. Then, the Connector 304 modifies the corresponding Node of the destination DOM tree. With such an arrangement, the Connector 304 is the only object which is capable of modifying the destination DOM tree. Specifically, the user can modify only the source document and the corresponding source DOM tree. With such an arrangement, the Connector 304 modifies the destination DOM tree according to the modification thus made by the user.

The Connectors 304 are logically linked to each other so as to form a tree structure. The tree structure formed of the Connectors 304 is referred to as a ConnectorTree (connector tree). The connector 304 is created using a Service which is called a ConnectorFactory (connector factory=connector generating unit) 303. The ConnectorFactory 303 creates the Connectors 304 based upon a source document, and links the Connectors 304 to each other so as to create a ConnectorTree. The VocabularyConnectionManager 302 holds the ConnectorFactory 303.

As described above, a vocabulary is a set of tags for a namespace. As shown in the drawing, the VocabularyConnection 301 creates the Vocabulary 305 for a document. Specifically, the Vocabulary 305 is created by analyzing the document file, and then creating a proper VocabularyConnectionManager 302 for mapping between the source DOM and the destination DOM. Furthermore, a proper relation is created between the ConnectorFactory 303 for creating the Connectors, the ZoneFactory 205 for creating the Zones 209, and the Editlet 206 for creating the Canvases. In a case that the user has discarded or deleted a document stored in the system, the corresponding VocabularyConnectionManager 302 is deleted.

The Vocabulary 305 creates the VCCanvas 310. Furthermore, the connectors 304 and the destination DOM tree 306 are created corresponding to the creation of the VCCanvas 310.

The source DOM and the Canvas correspond to the Model (M) and the View (V), respectively. However, such a representation is useful only in a case that the target vocabulary allows a document to be displayed on a screen. With such an arrangement, the display is performed by the vocabulary plug-in. Such a Vocabulary plug-in is provided for each of the principal vocabularies, e.g., XHTML, SVG, and MathML. Such a vocabulary plug-in is used for the target vocabulary. Such an arrangement provides a method for mapping a vocabulary to another vocabulary using a vocabulary connection descriptor.

Such mapping is useful only in a case that the target vocabulary can be mapped, and a method has been defined beforehand for displaying such a document thus mapped on a screen. Such a rendering method is defined in the form of a standard defined by an authority such as the W3C.

In a case that the processing requires vocabulary connection, the VCCanvas is used. In this case, the view for the source cannot be directly created, and accordingly, the Canvas for the source is not created. In this case, the VCCanvas is created using the ConnectorTree. The VCCanvas handles only the conversion of the event, but does not support display of the document on a screen.

3. DestinationZone, Pane, and Canvas

As described above, the purpose of the vocabulary connection sub-system is to create and hold two representations of a single document at the same time. With such an arrangement, the second representation is provided in the form of a DOM tree, which has been described as the destination DOM tree. The display of the document in the form of the second representation requires the DestinationZone, Canvas, and Pane.

When the VCCanvas is created, a corresponding DestinationPane 307 is also created. Furthermore, a corresponding DestinationCanvas 308 and a corresponding BoxTree 309 are created. Also, the VCCanvas 310 is associated with the Pane 211 and the Zone 209 for the source document.

The DestinationCanvas 308 provides a logical layout of a document in the form of the second representation. Specifically, the DestinationCanvas 308 provides user interface functions such as a cursor function and a selection function, for displaying a document in the form of a destination representation of the document. The event occurring at the DestinationCanvas 308 is supplied to the Connector. The DestinationCanvas 308 notifies the Connector 304 of the occurrence of a mouse event, a keyboard event, a drag-and-drop event, and events particular to the destination representation (second representation).

4. Vocabulary Connection Command Sub-System

The vocabulary connection (VC) sub-system 300 includes a vocabulary connection (VC) command sub-system 313 in the form of a component. The vocabulary connection command sub-system 313 creates a VCCommand (vocabulary connection command) 315 used for executing a command with respect to the vocabulary connection sub-system 300. The VCCommand can be created using a built-in CommandTemplate (command template) and/or created from scratch using a script language supported by a script sub-system 314.

Examples of such command templates include an “If” command template, “When” command template, “Insert” command template, etc. These templates are used for creating a VCCommand.

5. XPath Sub-System

An XPath sub-system 316 is an important component of the document processing system, and supports the vocabulary connection. In general, the Connector 304 includes XPath information. As described above, one of the tasks of the vocabulary connection is to modify the destination DOM tree according to the change in the source DOM tree. The XPath information includes one or more XPath representations used for determining a subset of the source DOM tree which is to be monitored to detect changes and/or modifications.

6. Outline of Source DOM Tree, Destination DOM Tree, and ConnectorTree

The source DOM tree is a DOM tree or a Zone of a document described in a vocabulary before vocabulary conversion. The source DOM tree Node is referred to as the source Node.

On the other hand, the destination DOM tree is a DOM tree or a Zone of the same document as that of the source DOM tree, and which is described in another vocabulary after having been converted by mapping, as described above in connection with the vocabulary connection. Here, the destination DOM tree Node is referred to as the destination Node.

The ConnectorTree is a hierarchical representation which is formed based upon the Connectors that represent the relation between the source Nodes and the destination Nodes. The Connectors monitor the source Node and the modifications applied to the source document, and modify the destination DOM tree. The Connector is the only object that is permitted to modify the destination DOM tree.

E. Event Flow in the Document Processing System

In practice, the program needs to respond to the commands input from the user. The “event” concept provides a method for describing and executing the user action executed on a program. Many high-level languages, e.g., Java (trademark) require events, each of which describes a corresponding user action. On the other hand, conventional programs need to actively collect information for analyzing the user's actions, and for execution of the user's actions by the program itself. This means that, after initialization of the program, the program enters loop processing for monitoring the user's actions, which enables appropriate processing to be performed in response to any user action input by the user via the screen, keyboard, mouse, or the like. However, such a process is difficult to manage. Furthermore, such an arrangement requires a program which performs loop processing in order to wait for the user's actions, leading to a waste of CPU cycles.

Many languages employ distinctive paradigms in order to solve such problems. One of these paradigms is event-driven programming, which is employed as the basis of all current window-based systems. In this paradigm, all user actions belong to sets of abstract phenomena which are called “events”. An event provides a sufficiently detailed description of a corresponding user action. With such an arrangement, in a case that an event to be monitored has occurred, the system notifies the program to that effect, instead of an arrangement in which the program actively collects events occurring according to the user's actions. A program that communicates with the user using such a method is referred to as an “event-driven” program.

In many cases, such an arrangement handles an event using a “Event” class that acquires the basic properties of all the events which can occur according to the user's actions.

Before the use of the document processing system, the events for the document processing system itself and a method for handling such events are defined. With such an arrangement, several types of events are used. For example, a mouse event is an event that occurs according to the action performed by the user via a mouse. The user action involving the mouse is transmitted to the mouse event by the Canvas 210. As described above, it can be said that the Canvas is the foremost level of interaction between the user and the system. As necessary, this foremost Canvas level hands over the event content to the child levels.

On the other hand, a keystroke event is issued from the Canvas 210. The keystroke event acquires a real-time focus. That is to say, a keystroke event always involves an operation. The keystroke event input to the Canvas 210 is also transmitted to the parent of the Canvas 210. Key input actions are processed via other events that allow the user to insert a character string. The event for handling the insertion of a character string occurs according to the user action in which a character is input via the keyboard. Examples of “other events” include other events which are handled in the same way as a drag event, a drop event, and a mouse event.

1. Handling of an Event Outside of the Vocabulary Connection

An event is transmitted using an event thread. The state of the Canvas 210 is modified upon reception of an event. As necessary, the Canvas 210 posts the Command 1052 to the CommandQueue 1053.

2. Handling of an Event within the Vocabulary Connection

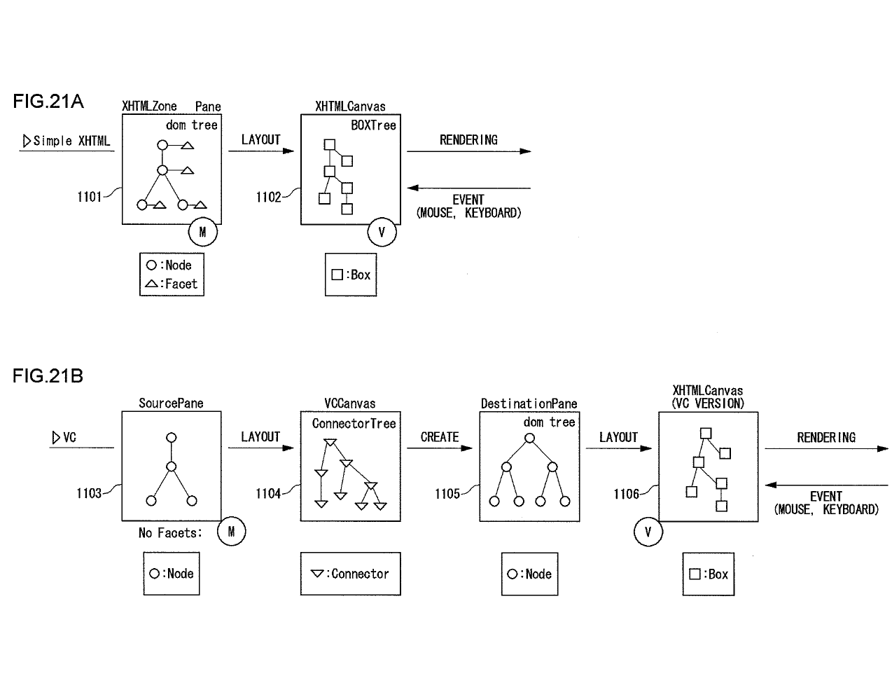

An XHTMLCanvas 1106, which is an example of the DestinationCanvas, receives events that occur, e.g., a mouse event, a keyboard event, a drag-and-drop event, and events particular to the vocabulary, using the VocabularyConnection plug-in 301. The connector 304 is notified of these events. More specifically, the event passes through a SourcePane 1103, a VCCanvas 1104, a DestinationPane 1105, a DestinationCanvas 1106 which is an example of the DestinationCanvas, a destination DOM tree, and a ConnectorTree, within the VocabularyConnection plug-in, as shown in FIG. 21(b).

F. ProgramInvoker and the Relation Between ProgramInvoker and Other Components

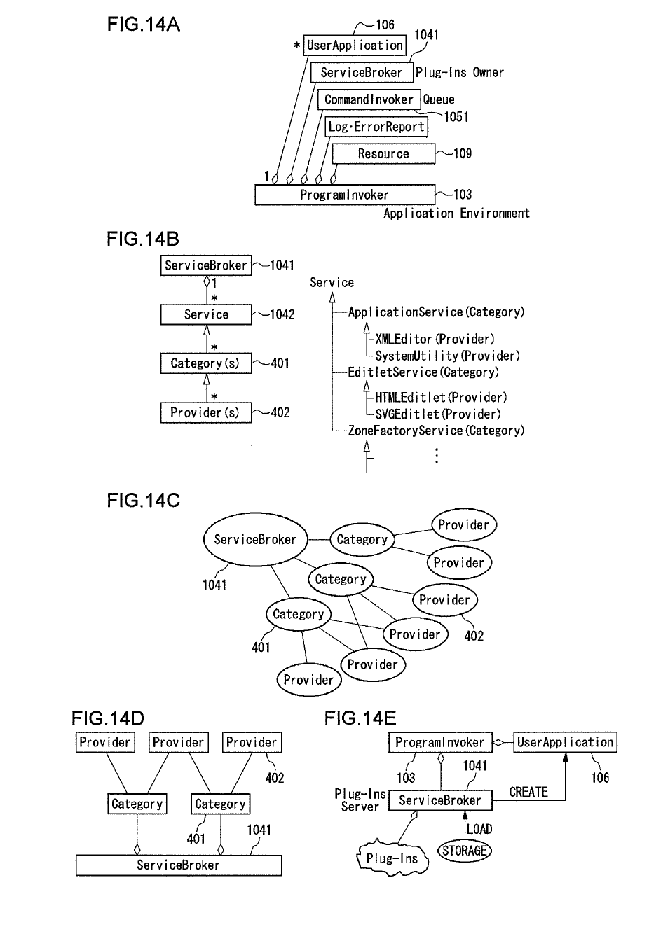

FIG. 14(a) shows the ProgramInvoker 103 and the relation between the ProgramInvoker 103 and other components in more detail. The ProgramInvoker 103 is a basic program executed under the execution environment, which starts up the document processing system. As shown in FIG. 11(b) and FIG. 11(c), the UserApplication 106, the ServiceBroker 1041, the CommandInvoker 1051, and the Resource 109 are each connected to the ProgramInvoker 103. As described above, the application 102 is a component executed under the execution environment. Also, the ServiceBroker 1041 manages the plug-ins, which provide various functions to the system. On the other hand, the CommandInvoker 1051 executes a command provided from the user, and holds the classes and functions for executing the command.

1. Plug-In and Service

A more detailed description will be made regarding the ServiceBroker 1041 with reference to FIG. 14(b). As described above, the ServiceBroker 1041 manages the plug-ins (and corresponding services), which allows various functions to be added to the system. The Service 1042 is the lowermost layer, having a function of adding the features to the document processing system, and a function of modifying the features of the document processing system. A “Service” consists of two parts, i.e., a part formed of ServiceCategories 401 and another part formed of ServiceProviders 402. As shown in FIG. 14(c), one ServiceCategory 401 may include multiple corresponding ServiceProviders 402. Each ServiceProvider operates a part of, or the entire functions of, the corresponding ServiceCategory. Also, the ServiceCategory 401 defines the type of Service.

The Services can be classified into three types, i.e., a “feature service” which provides predetermined features to the document processing system, an “application service” which is an application executed by the document processing system, and an “environment” service that provides the features necessary throughout the document processing system.

FIG. 14(d) shows an example of a Service. In this example, with respect to the Category of the application Service, the system utility corresponds to the ServiceProvider. In the same way, the Editlet 206 is the Category, and an HTMLEditlet and the SVGEditlet are the corresponding ServiceProviders. Also, the ZoneFactory 205 is another Service Category, and has a corresponding ServiceProvider (not shown).

As described above, a plug-in adds functions to the document processing system. Also, a plug-in can be handled as a unit that comprises several ServiceProviders 402 and the classes that correspond to the ServiceProviders 402. Each plug-in has dependency specified in the definition file and a ServiceCategory 401.

2. Relation Between the ProgramInvoker and the Application

FIG. 14(e) shows the relation between the ProgramInvoker 103 and the UserApplication 106 in more detail. The required documents and data are loaded from the storage. All the required plug-ins are loaded in the ServiceBroker 1041. The ServiceBroker 1041 holds and manages all the plug-ins. Each plug-in is physically added to the system. Also, the functions of the plug-in can be loaded from the storage. When the content of a plug-in is loaded, the ServiceBroker 1041 defines the corresponding plug-in. Subsequently, a corresponding UserApplication 106 is created, and the UserApplication 106 thus created is loaded in the execution environment 101, thereby attaching the plug-in to the ProgramInvoker 103.

G. The Relation Between the Application Service and the Environment

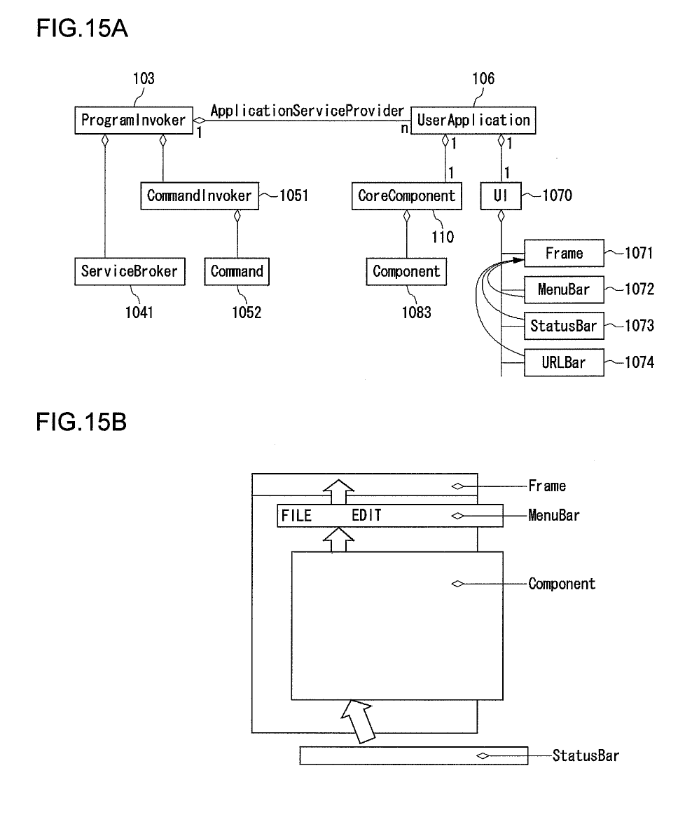

FIG. 15(a) shows the configuration of the application service loaded in the ProgramInvoker 103 in more detail. The CommandInvoker 1051, which is a component of the command sub-system 105, starts up or executes the Command 1052 in the ProgramInvoker 103. With such a document processing system, the Command 1052 is a command used for processing a document such as an XML document, and editing the corresponding XML DOM tree. The CommandInvoker 1051 holds the classes and functions required to execute the Command 1052.

Also, the ServiceBroker 1041 is executed within the ProgramInvoker 103. The UserApplication 106 is connected to the user interface 107 and the CoreComponent 110. The CoreComponent 110 provides a method which allows all the Panes to share a document. Furthermore, the CoreComponent 110 provides a font, and serves as a tool kit for the Pane.

FIG. 15(b) shows the relation between the Frame 1071, the MenuBar 1072, and the StatusBar 1073.

H. Application Core

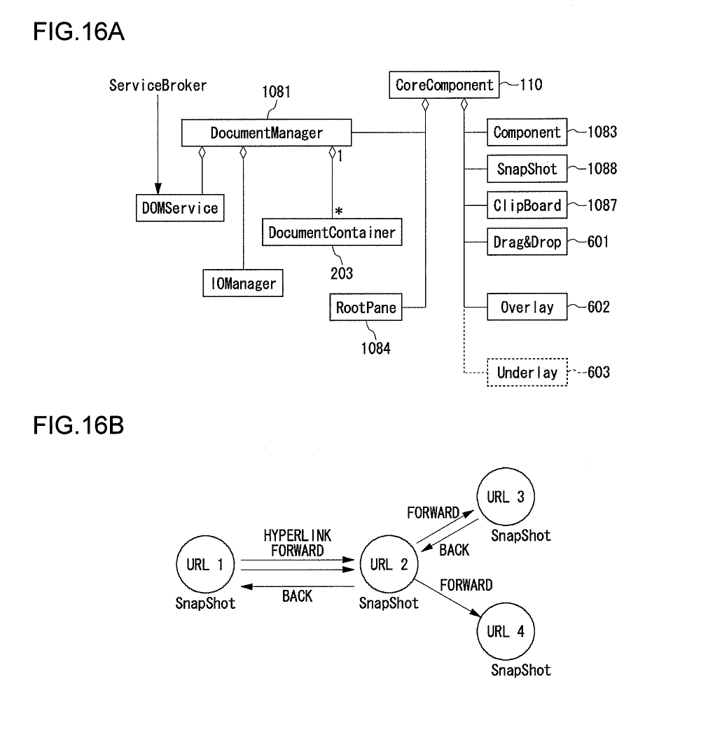

FIG. 16(a) provides a more detailed description of the application core 108, which holds the whole document, and a part of the document, and the data of the document. The CoreComponent 110 is attached to the DocumentManager 1081 for managing the documents 1082. The DocumentManager 1081 is the owner of all the documents 1082 stored in memory in association with the document processing system.

In order to display a document on a screen in a simple manner, the DocumentManager 1081 is also connected to the RootPane 1084. Also, the functions of the Clipboard 1087, a Drag&Drop 601, and an Overlay 602 are attached to the CoreComponent 110.

The SnapShot 1088 is used for restoring the application to a given state. Upon the user executing the SnapShot 1088, the current state of the application is detected and stored. Subsequently, when the application state changes, the content of the application state thus stored is maintained. FIG. 16(b) shows the operation of the SnapShot 1088. With such an arrangement, upon the application switching from one URL to another, the SnapShot 1088 stores the previous state. Such an arrangement allows operations to be performed forward and backward in a seamless manner.

I. Document Structure within the DocumentManager

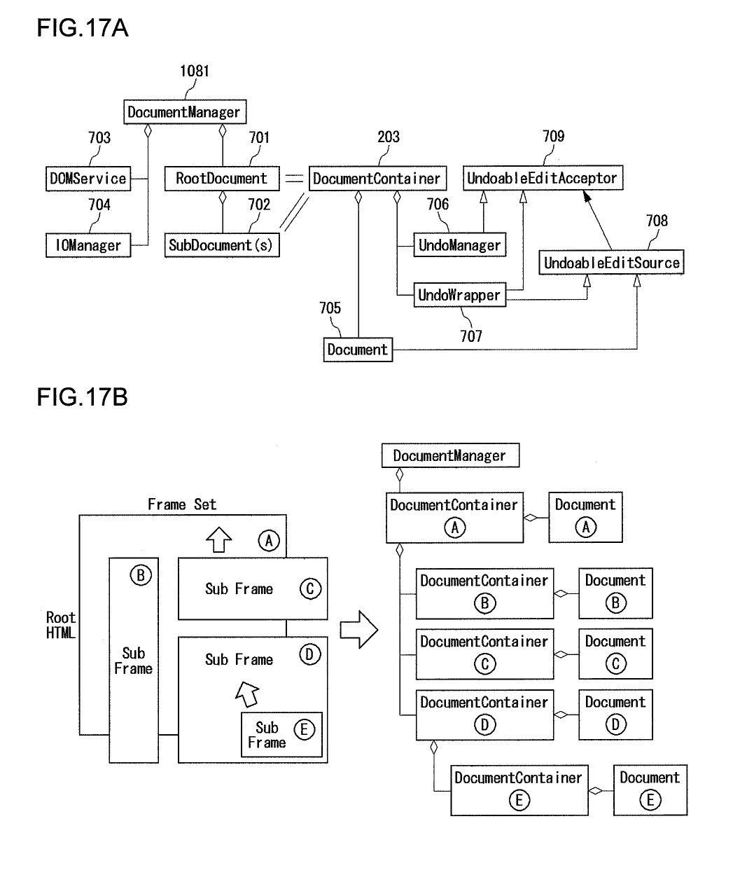

FIG. 17(a) provides a more detailed description of the DocumentManager 1081, and shows the DocumentManager holding documents according to a predetermined structure. As shown in FIG. 11(b), the DocumentManager 1081 manages the documents 1082. With an example shown in FIG. 17(a), one of the multiple documents is a RootDocument (root document) 701, and the other documents are SubDocuments (sub-documents) 702. The DocumentManager 1081 is connected to the RootDocument 701. Furthermore, the RootDocument 701 is connected to all the SubDocuments 702.

As shown in FIG. 12 and FIG. 17(a), the DocumentManager 1081 is connected to the DocumentContainer 203, which is an object for managing all the documents 1082. The tools that form a part of the tool kit 201 (e.g., XML tool kit) including a DOMService 703 and an IOManager 704 are supplied to the DocumentManager 1081. Referring to FIG. 17(a) again, the DOM service 703 creates a DOM tree based upon a document managed by the DocumentManager 1081. Each document 705, whether it is a RootDocument 701 or a SubDocument 702, is managed by a corresponding DocumentContainer 203.

FIG. 17(b) shows the documents A through E managed in a hierarchical manner. The document A is a RootDocument. On the other hand, the documents B through D are the SubDocuments of the document A. The document E is the SubDocument of the document D. The left side in FIG. 17(b) shows an example of the documents displayed on a screen according to the aforementioned hierarchical management structure. In this example, the document A, which is the RootDocument, is displayed in the form of a base frame. On the other hand, the documents B through D, which are the SubDocuments of the document A, are displayed in the form of sub-frames included in the base frame A. On the other hand, the document E, which is the SubDocument of the document D, is displayed on a screen in the form of a sub-frame of the sub-frame D.

Referring to FIG. 17(a) again, an UndoManager (undo manager=undo management unit) 706 and an UndoWrapper (undo wrapper) 707 are created for each DocumentContainer 203. The UndoManager 706 and the UndoWrapper 707 are used for executing an undoable command. Such a feature allows the user to reverse a modification which has been applied to the document according to an editing operation. Here, the modification of the SubDocument significantly affects the RootDocument. The undo operation performed under such an arrangement gives consideration to the modification that affects other hierarchically managed documents, thereby preserving the document integrity over all the documents managed in a particular hierarchical chain, as shown in FIG. 17(b), for example.

The UndoWrapper 707 wraps undo objects with respect to the SubDocuments stored in the DocumentContainer 203. Then, the UndoWrapper 707 connects the undo objects thus wrapped to the undo object with respect to the RootDocument. With such an arrangement, the UndoWrapper 707 acquires available undo objects for an UndoableEditAcceptor (undoable edit acceptor=undoable edit reception unit) 709.

The UndoManager 706 and the UndoWrapper 707 are connected to the UndoableEditAcceptor 709 and an UndoableEditSource (undoable edit source) 708. Note that the Document 705 may be the UndoableEditSource 708 or a source of an undoable edit object, as can be readily understood by those skilled in this art.

J. Undo Command and Undo Framework

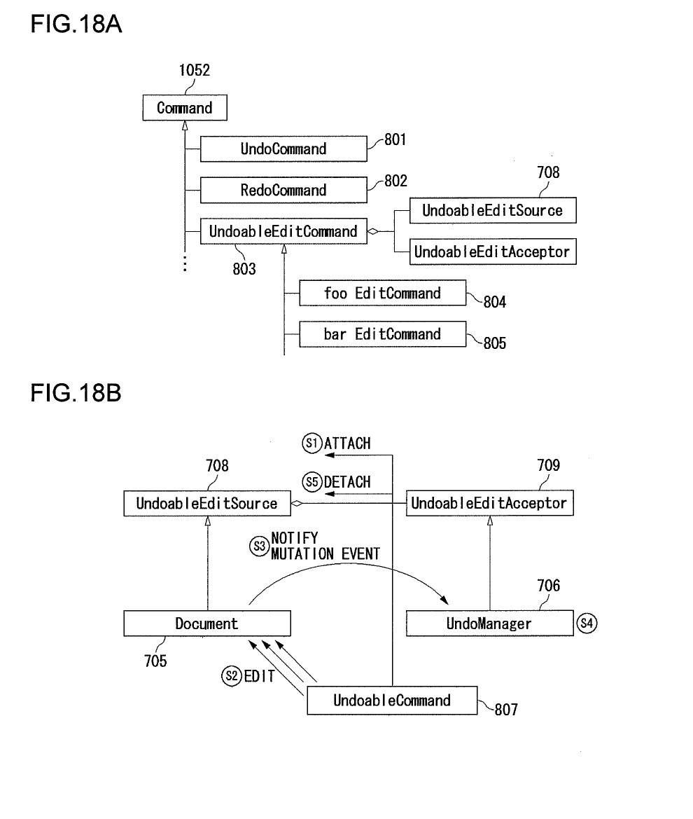

FIG. 18(a) and FIG. 18(b) provide a more detailed description with respect to an undo framework and an undo command. As shown in FIG. 18(a), an UndoCommand 801, RedoCommand 802, and an UndoableEditCommand 803 are commands that can be loaded in the CommandInvoker 1051, and which are serially executed. The UndoableEditCommand 803 is further attached to the UndoableEditSource 708 and the UndoableEditAcceptor 709. Examples of such undoableEditCommands include a “foo” EditCommand 804 and a “bar” EditCommand 805.

1. Execution of UndoableEditCommand

FIG. 18(b) shows execution of the UndoableEditCommand. First, let us consider a case in which the user edits the Document 705 using an edit command. In the first step S1, the UndoableEditAcceptor 709 is attached to the UndoableEditSource 708 which is a DOM tree of the Document 705. In the second step S2, the Document 705 is edited using an API for the DOM according to a command issued by the user. In the third step S3, a listener of the mutation event is notified of the modification. That is to say, in this step, the listener that monitors all modifications made to the DOM tree detects such an edit operation. In the fourth step S4, the UndoableEdit is stored as an object of the UndoManager 706. In the fifth step S5, the UndoableEditAcceptor 709 is detached from the UndoableEditSource 708. Here, the UndoableEditSource 708 may be the Document 705 itself.

K. Procedure for Loading a Document to the System

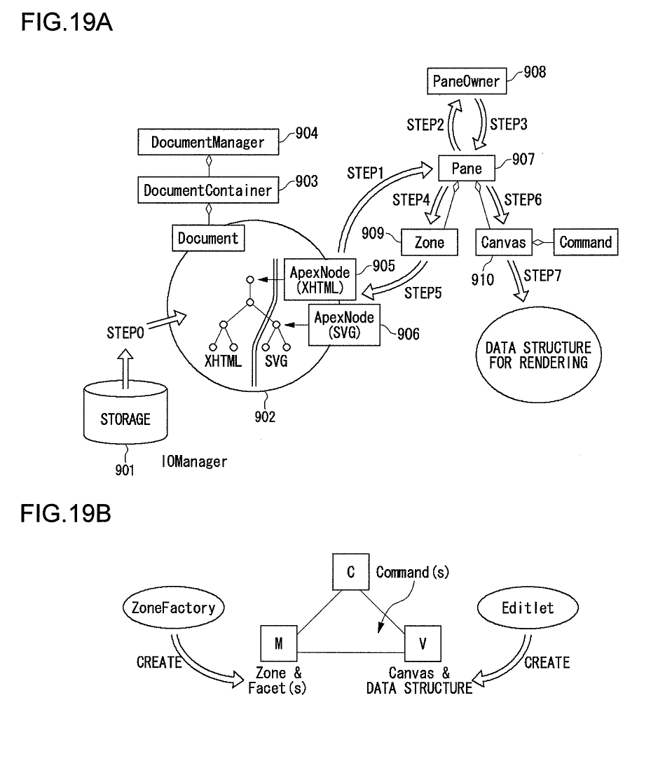

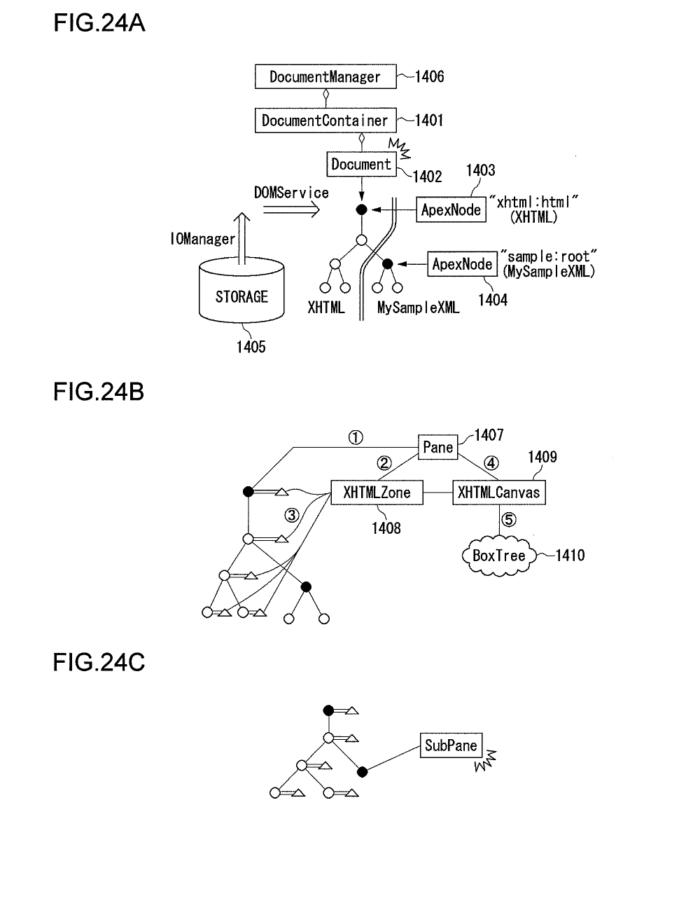

Description has been made in the aforementioned sub-sections regarding various components and sub-components of the system. Description will be made below regarding methods for using such components. FIG. 19(a) shows the outline of the operation for loading a document to the document processing system. Detailed description will be made regarding each step with reference to examples shown in FIGS. 24 through 28.

In brief, the document processing system creates a DOM based upon the document data which is provided in the form of a binary data stream. First, an ApexNode (apex Node=top Node) is created for the targeted part of the document, which is a part of the document that belongs to the Zone. Subsequently, the corresponding Pane is identified. The Pane thus identified creates the Zone and Canvas from the ApexNode and the physical screen. Then, the Zone creates a Facet for each Node, and provides the necessary information to the Facets. On the other hand, the Canvas creates a data structure for rendering the Nodes based upon the DOM tree.

More specifically, the document is loaded from a storage 901. Then, a DOM tree 902 of the document is created. Subsequently, a corresponding DocumentContainer 903 is created for holding the document. The DocumentContainer 903 is attached to the DocumentManager 904. The DOM tree includes the root Node, and in some cases includes multiple secondary Nodes.

Such a document generally includes both text data and graphics data. Accordingly, the DOM tree may include an SVG sub-tree, in addition to an XHTML sub-tree. The XHTML sub-tree includes an ApexNode 905 for XHTML. In the same way, the SVG sub-tree includes an ApexNode 906 for SVG.

In Step 1, the ApexNode 906 is attached to a Pane 907 which is a logical layout of the screen. In Step 2, the Pane 907 issues a request for the CoreComponent which is the PaneOwner (pane owner=owner of the pane) 908 to provide a ZoneFactory for the ApexNode 906. In Step 3, in the form of a response, the PaneOwner 908 provides the ZoneFactory and the Editlet which is a CanvasFactory for the ApexNode 906.

In Step 4, the Pane 907 creates a Zone 909. The Zone 909 is attached to the Pane 907. In Step 5, the Zone 909 creates a Facet for each Node, and attaches the Facets thus created to the respective Nodes. In Step 6, the Pane 907 creates a Canvas 910. The Canvas 910 is attached to the Pane 907. The Canvas 910 includes various Commands. In Step 7, the Canvas 910 creates a data structure for rendering the document on a screen. In a case of XHTML, the data structure includes a box tree structure.

1. MVC of the Zone

FIG. 19(b) shows the outline of a structure of the Zone using the MVC paradigm. In this case, with respect to a document, the Zone and the Facets are the input, and accordingly the model (M) includes the Zone and the Facets. On the other hand, the Canvas and the data structure for rendering a document on a screen are the output, in the form of an image displayed on a screen for the user. Accordingly, the view (V) corresponds to the Canvas and the data structure. The Command executes control operations for the document and the various components that correspond to the document. Accordingly, the control (C) includes the Commands included in the Canvas.

L. Representation of a Document

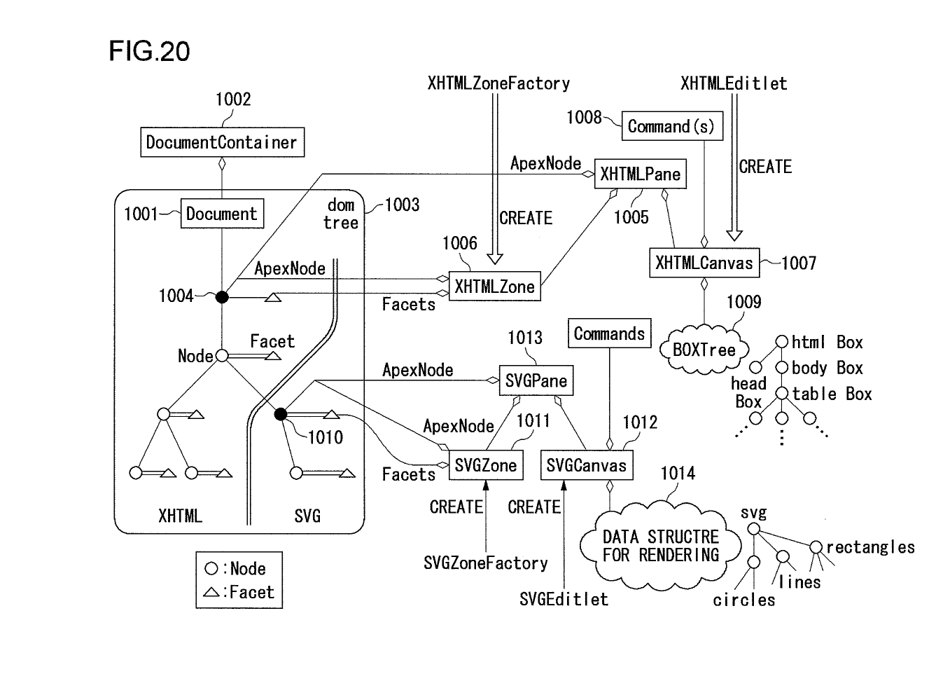

Description will be made below regarding an example of a document and various representations thereof. The document used in this example includes both text data and image data. The text data is represented using XHTML, and the image data is represented using SVG. FIG. 20 shows in detail the relation between the components of the document and the corresponding objects represented in the MVC. In this example, a Document 1001 is attached to a DocumentContainer 1002 for holding the Document 1001. The document is represented in the form of a DOM tree 1003. The DOM tree includes an ApexNode 1004.

The ApexNode is indicated by a solid circle. Each of the Nodes other than the ApexNode is indicated by an empty circle. Each Facet used for editing the Node is indicated by a triangle, and is attached to the corresponding Node. Here, the document includes text data and image data. Accordingly, the DOM tree of the document includes an XHTML component and an SVG component. The ApexNode 1004 is the top Node of the XHTML sub-tree. The ApexNode 1004 is attached to an XHTMLPane 1005 which is the top pane for physically representing the XHTML component of the document. Furthermore, the ApexNode 1004 is attached to an XHTMLZone 1006 which is a part of the DOM tree of the document.

Also, the Facet that corresponds to the Node 1004 is attached to the XHTMLZone 1006. The XHTMLZone 1006 is attached to the XHTMLPane 1005. The XHTMLEditlet creates a XHTMLCanvas 1007 which is a logical representation of the document. The XHTMLCanvas 1007 is attached to the XHTMLPane 1005. The XHTMLCanvas 1007 creates a BoxTree 1009 for the XHTML component of the Document 1001. Various commands 1008 necessary for holding and displaying the XHTML component of the document are added to the XHTMLCanvas 1007.

In the same way, an ApexNode 1010 of the SVG sub-tree of the document is attached to an SVGZone 1011 which is a part of the DOM tree of the document 1001, and which represents the SVG component of the document. The ApexNode 1010 is attached to an SVGPane 1013 which is the top Pane for physically representing the SVG part of the document. An SVGCanvas 1012 for logically representing the SVG component of the document is created by the SVGEditlet, and is attached to an SVGPane 1013. The data structure and the commands for rendering the SVG component of the document on a screen are attached to the SVGCanvas. For example, this data structure may include circles, lines, and rectangles, and so forth, as shown in the drawing.

While description has been made regarding the representation of a document with reference to FIG. 20, further description will be made regarding a part of such examples of the representations of the document using the above-described MVC paradigm with reference to FIG. 21(a). FIG. 21(a) shows a simplified relation between M and V (MV) with respect to the XHTML components of the document 1001. In this case, the model is the XHTMLZone 1101 for the XHTML component of the Document 1001. The tree structure of the XHTMLZone includes several Nodes and the corresponding Facets. With such an arrangement, the corresponding XHTMLZone and the Pane are a part of the model (M) component of the MVC paradigm. On the other hand, the view (V) component of the MVC paradigm corresponds to the XHTMLCanvas 1102 and the BoxTree that correspond to the XHTML component of the Document 1001. With such an arrangement, the XHTML component of the document is displayed on a screen using the Canvas and the Commands included in the Canvas. Note that the events occurring due to the keyboard action and the mouse input proceed in the opposite direction to that of the output.

The SourcePane provides an additional function, i.e., serves as a DOM owner. FIG. 21(b) shows the operation in which the vocabulary connection is provided for the components of the Document 1001 shown in FIG. 21(a). The SourcePane 1103 that serves as a DOM holder includes a source DOM tree of the document. The ConnectorTree is created by the ConnectorFactory, and creates the DestinationPane 1105 which also serves as an owner of the destination DOM. The DestinationPane 1105 is provided in the form of the XHTMLDestinationCanvas 1106 having a box tree layout.

M. The Relation Between Plug-In Sub-System, Vocabulary Connection, and Connector

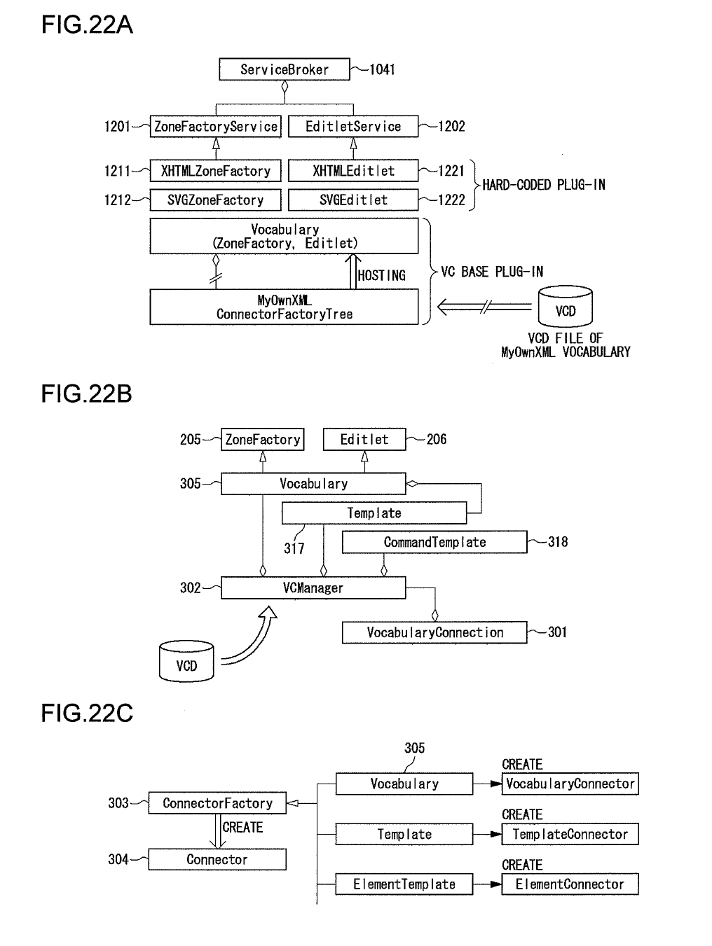

FIGS. 22(a) through 22(c) provide further detailed description with respect to the plug-in sub-system, the vocabulary connection, and the Connector, respectively. The Plug-in sub-system is used for adding a function to the document processing system or for replacing a function of the document processing system. The plug-in sub-system includes the ServiceBroker 1041. A ZoneFactoryService 1201 attached to the ServiceBroker 1041 creates a Zone that corresponds to a part of the document. Also, an EditletService 1202 is attached to the ServiceBroker 1041. The EditletService 1202 creates a Canvas that corresponds to the Nodes included in the Zone.

Examples of the ZoneFactories include an XHTMLZoneFactory 1211 and an SVGZoneFactory 1212, which create an XHTMLZone and an SVGZone, respectively. As described above with reference to an example of the document, the text components of the document may be represented by creating an XHTMLZone. On the other hand, the image data may be represented using an SVGZone. Examples of the EditletService include an XHTMLEditlet 1221 and an SVGEditlet 1222.

FIG. 22(b) shows the vocabulary connection in more detail. The vocabulary connection is an important feature of the document processing system, which allows a document to be represented and displayed in two different manners while maintaining the integrity of the document. The VCManager 302 that holds the ConnectorFactory 303 is a part of the vocabulary connection sub-system. The ConnectorFactory 303 creates the Connector 304 for the document. As described above, the Connector monitors the Node included in the source DOM, and modifies the Node included in the destination DOM so as to maintain the integrity of the connection between the two representations.

A Template 317 represents several Node conversion rules. The vocabulary connection descriptor (VCD) file is a template list which represents several rules for converting a particular path, an element, or a set of elements that satisfies a predetermined rule into another element. All the Templates 317 and CommandTemplates 318 are attached to the VCManager 302. The VCManager is an object for managing all the sections included in the VCD file. A VCManager object is created for each VCD file.

FIG. 22(c) provides further detailed description with respect to the Connector. The ConnectorFactory 303 creates a Connector based upon the source document. The ConnectorFactory 303 is attached to the Vocabulary, the Template, and the ElementTemplate, thereby creating a VocabularyConnector, a TemplateConnector, and an ElementConnector, respectively.

The VCManager 302 holds the ConnectorFactory 303. In order to create a Vocabulary, the corresponding VCD file is read out. As described above, the ConnectorFactory 303 is created. The ConnectorFactory 303 corresponds to the ZoneFactory for creating a Zone, and the Editlet for creating a Canvas.

Subsequently, the EditletService for the target vocabulary creates a VCCanvas. The VCCanvas also creates the Connector for the ApexNode included in the source DOM tree or the Zone. As necessary, a Connector is created recursively for each child. The ConnectorTree is created using a set of the templates stored in the VCD file.

The template is a set of rules for converting elements of a markup language to other elements. For example, each template is matched to a source DOM tree or a Zone. In a case of a suitable match, an apex Connector is created. For example, a template “A/*/D” matches all the branches starting from the Node A and ending with the Node D. In the same way, a template “//B” matches all the “B” Nodes from the root.

N. Example of VCD File with Respect to ConnectorTree

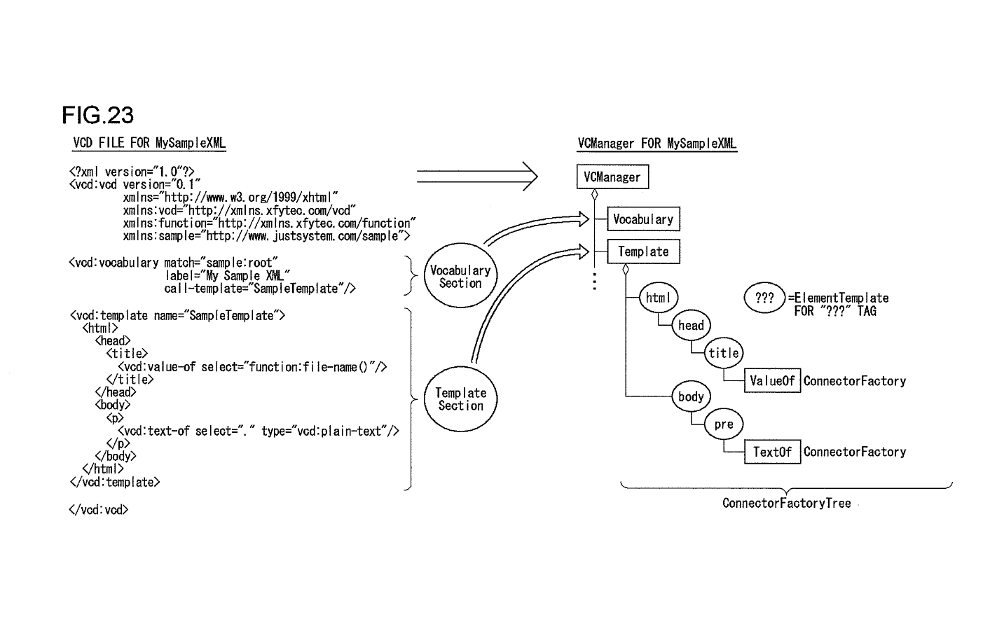

Further description will be made regarding an example of the processing with respect to a predetermined document. In this example, a document entitled “MySampleXML” is loaded in the document processing system. FIG. 23 shows an example of the VCD script for the “MySampleXML” file, which uses the VCManager and the ConnectorFactoryTree. In this example, the script file includes a vocabulary section, a template section, and a component that corresponds to the VCManager. With regard to the tag “vcd:vocabulary”, the attribute “match” is set to “sample:root”, the attribute “label” is set to “MySampleXML”, and the attribute “call-template” is set to “sample template”.

In this example, with regard to the VCManager for the document “MySampleXML”, the Vocabulary includes the apex element “sample:root”. The corresponding UI label is “MySampleXML”. In the template section, the tag is “vcd:template”, and the name is set to “sample:template”.

O. Detailed Description of an Example of a Method for Loading a File to the System

FIGS. 24 through 28 provide a detailed description regarding loading the document “MySampleXML” in the system. In Step 1 shown in FIG. 24(a), the document is loaded from a storage 1405. The DOMService creates a DOM tree and a DocumentContainer 1401 that corresponds to the DocumentManager 1406. The DocumentContainer 1401 is attached to the DocumentManager 1406. The document includes an XHTML sub-tree and a MySampleXML sub-tree. With such a document, the ApexNode 1403 in the XHTML sub-tree is the top Node of the XHTML sub-tree, to which the tag “xhtml:html” is assigned. On the other hand, the ApexNode 1404 in the “MySampleXML” sub-tree is the top Node of the “MySampleXML” sub-tree, to which the tag “sample:root” is assigned.

In Step S2 shown in FIG. 24(b), the RootPane creates an XHTMLZone, Facets, and a Canvas. Specifically, a Pane 1407, an XHTMLZone 1408, an XHTMLCanvas 1409, and a BoxTree 1410 are created corresponding to the ApexNode 1403.

In Step S3 shown in FIG. 24(c), the tag “sample:root” that is not understood under the XHTMLZone sub-tree is detected, and a SubPane is created in the XHTMLCanvas region.

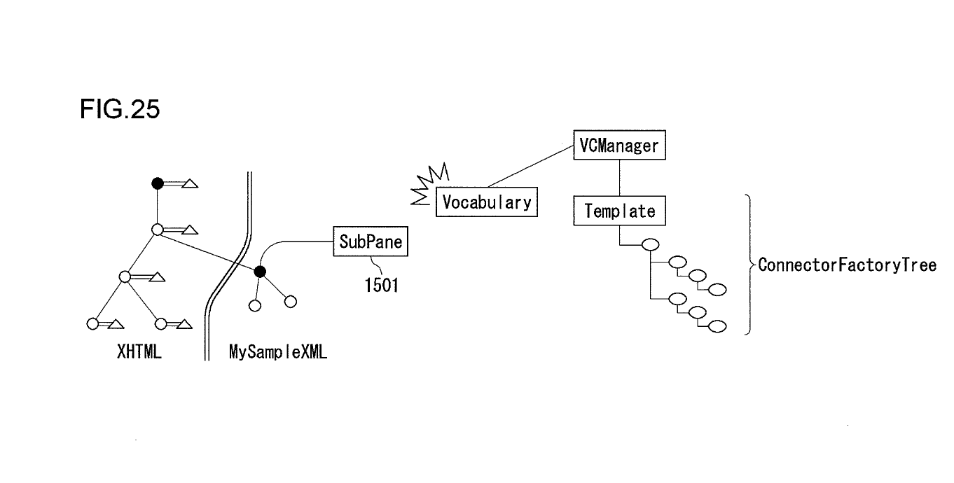

In Step 4 shown in FIG. 25, the SubPane can handle the “sample:root”, thereby providing a ZoneFactory having a function of creating an appropriate zone. The ZoneFactory is included in the vocabulary, and the vocabulary can execute the ZoneFactory. The vocabulary includes the content of the VocabularySection specified in “MySampleXML”.

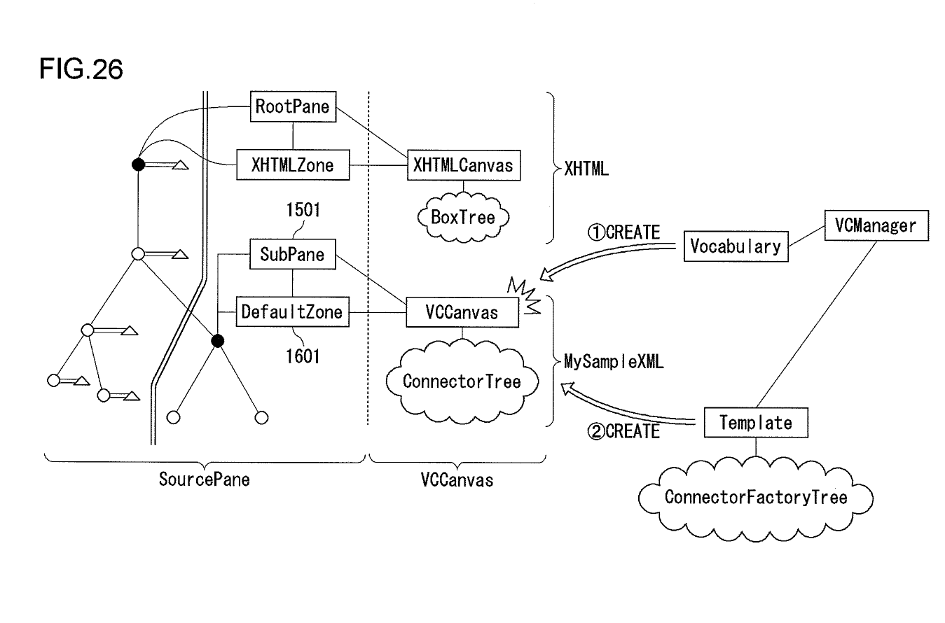

In Step 5 shown in FIG. 26, the Vocabulary that corresponds to “MySampleXML” creates a DefaultZone 1601. In order to create a corresponding Editlet for creating a corresponding Canvas, a SubPane 1501 is provided. The Editlet creates a VCCanvas. The VCCanvas calls the TemplateSection including a ConnectorFactoryTree. The ConnectorFactoryTree creates all the connectors that form the ConnectorTree.

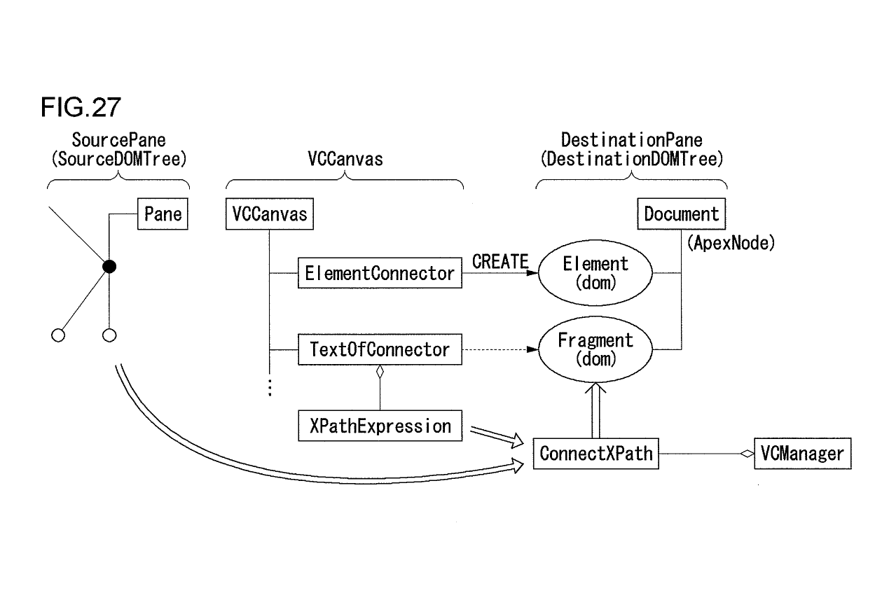

In Step S6 shown in FIG. 27, each Connector creates a corresponding destination DOM object. Some of the connectors include XPath information. Here, the XPath information includes one or more XPath representations used for determining a partial set of the source DOM tree which is to be monitored for changes and modifications.

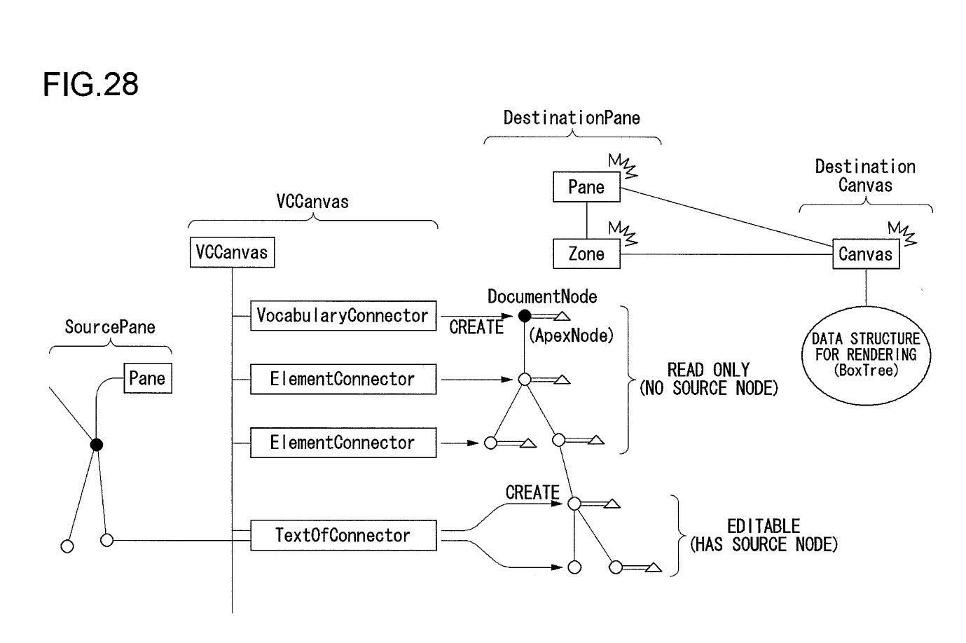

In Step S7 shown in FIG. 28, the vocabulary creates a DestinationPane for the destination DOM tree based upon the pane for the source DOM. Specifically, the DestinationPane is created based upon the SourcePane. The ApexNode of the destination tree is attached to the DestinationPane and the corresponding Zone. The DestinationPane creates a DestinationCanvas. Furthermore, the DestinationPane is provided with a data structure for rendering the document in a destination format and an Editlet for the DestinationPane itself.

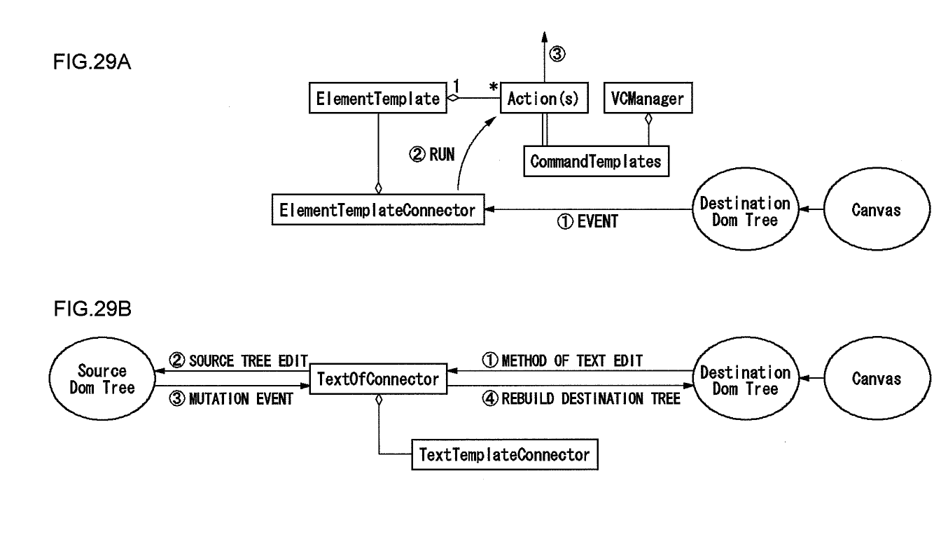

FIG. 29(a) shows a flow in a case in which an event has occurred at a Node in the destination tree that has no corresponding source Node. In this case, the event acquired by the Canvas is transmitted to an ElementTemplateConnector via the destination tree. The ElementTemplateConnector has no corresponding source Node, and accordingly, the event thus transmitted does not involve an edit operation for the source Node. In a case that the event thus transmitted matches any of the commands described in the CommandTemplate, the ElementTemplateConnector executes the Action that corresponds to the command. On the other hand, in a case that there is no corresponding command, the ElementTemplateConnector ignores the event thus transmitted.

FIG. 29(b) shows a flow in a case in which an event has occurred at a Node in the destination tree that has been associated with a source Node via a TextOfConnector. The TextOfConnector acquires the text Node from the Node in the source DOM tree specified by the XPath, and maps the text Node to the corresponding Node in the destination DOM tree. The event acquired by the Canvas, such as a mouse event, a keyboard event, or the like, is transmitted to the TextOfConnector via the destination tree. The TextOfConnector maps the event thus transmitted to a corresponding edit command for the corresponding source Node, and the edit command thus mapped is loaded in the CommandQueue 1053. The edit commands are provided in the form of an API call set for the DOM executed via the Facet. When the command loaded in the queue is executed, the source Node is edited. When the source Node is edited, a mutation event is issued, thereby notifying the TextOfConnector, which has been registered as a listener, of the modification of the source Node. Then, the TextOfConnector rebuilds the destination tree such that the destination Node is modified according to the modification of the source Node. In this stage, in a case that the template including the TextOfConnector includes a control statement such as “for each”, “for loop”, or the like, the ConnectorFactory reanalyzes the control statement. Furthermore, the TextOfConnector is rebuilt, following which the destination tree is rebuilt.

The outline of the present invention:

The description will now be given of how the present system that provides an XML (eXtensible Markup Language) compound document processing framework can produce a new document processing paradigm in the Semantic Computing era, in consideration of a new generation of document processing. In the conventional document processing, WYSYWIG (What You See Is What You Get) is a central concept, and creating a good-looking document was a main purpose thereof. In fact, the function of information distribution is important in that an appearance that is easy to understand facilitates an understanding. However, being easy to understand for a writer and being easy to understand for a reader are not always the same. The agreement of the understanding depends on the efforts of the reader. In addition, documents have another important purpose of upgrading information included in the document to “knowledge” and utilizing the knowledge repeatedly to create an additional value. In the current document processing environment, however, the document is just locally used in many cases, so it is hard to say that the process of integrating various types of information and creating a new knowledge is achieved. In order to enhance the function of conveying information by means of a document, reuse the document, and upgrade the document to a new valuable thing, a new type of document processing platform is necessary to satisfy the conditions that the information in the document can be handled on a fine granularity basis, plural documents can be integrated freely, the semantic processing can be included, and so on.

The inventor of the present invention has conceived of a new generation of document processing platform that satisfies the above conditions, and implements core functions therein.

(Base Technology)

In today's knowledge society, an advanced knowledge management is desired. The knowledge management has main tasks of information sharing and information utilization by use of IT technologies for the purpose of synchronizing the methodology and practice of management innovation centered around knowledge. In the knowledge management system, it is ideal to lead the document serving as a knowledge source to the knowledge creation, by reusing the document that is a representation of explicit knowledge and by mining the knowledge in the document. Specifically, techniques of information retrieval, information analysis, text mining, etc. are applied; however, the techniques have not yet reached the level by which the semantic content of the information is handled and a high-quality support is provided.

Meanwhile, approaches are proposed in which business documents are written in XML such as UBL (Universal Business Language), xCBL (XML Common Business Library), and XBRL (eXtensible Business Reporting Language) in a structured manner and are mutually utilized. MPEG-7 presents standards for applying meta information to all types of multimedia information such as image and sound. The above standards clarify the structural information of the business document that is one of core requirements of business protocols, thereby eliminating ambiguity in the interpretation in the company or between companies, and in addition, enhanced effects of business efficiency by use of the machine processing are expected.

In addition, XML tags entail the semantic contents thereof, and are capable of causing the machine to process the content based on semantics. The XML tags give one solution to the qualitative problem in processing the text information. For example, QA retrieval is available for information retrieval. Furthermore, the advancements of the technique of processing a natural language allows applying a practical annotation automatically, depending on the application, even in a freely described text without a tag.

Under the present circumstances; however, it is necessary to develop a dedicated XML editor or application for each XML vocabulary or use a dedicated tool in which plural vocabularies are statically merged. It is true these have not found widespread use despite expectations for advantages. Also, in consideration of the semantic processing, there is one aspect of the technical constraint in the technique of processing the natural language, and there is another aspect of difficulty in providing the whole of the semantic tags in advance, while assuming all scenes where the tags are used.

The present embodiment discusses, in the following five chapters, that the present system is capable of providing a new document processing environment by addressing the above issues in the application of XML and maximizing the advantages of XML.

Firstly, the first chapter [1. Business Document and Meta Structure] will review multilayered information structure of a document, and discusses the significance and points to be noted in handling each of partial units of information constituting the document independently, in light of the difference in the mental model between a writer and a reader.

Next, the second chapter [2. Semantic Processing by Use of Meta Information] will discuss that the meta information is useful in processing a partial constitutional element of the document, and also discusses a framework for dynamically constituting the meta information with the semantic processing added thereto.

In addition, the third chapter [3. Framework of the Present System] will outline the core technique of the present system together with the appeal points of the first and second chapters.

The fourth chapter [4. Conclusion] will conclude that the present system is capable of satisfying the requirements for a new generation of the document processing platform. Lastly, the fifth chapter [5. Additional Remarks] will describe the present embodiment in additional details.

[1. Business Document and Meta Structure]

1-1. Information Structure of Document

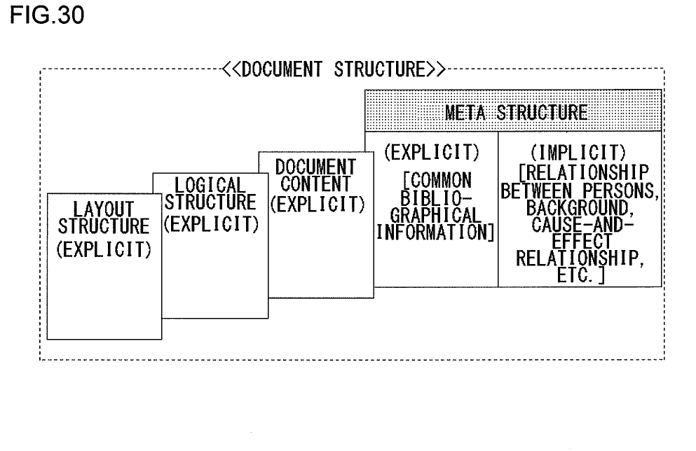

FIG. 30 is a schematic diagram which shows an information structure of a document.

The information structure of a single document can be treated as a multilayered structure, described as follows, in light of explicit and implicit structures.

The layout structure is an information structure relating to the representation style of the document such as a format or an arrangement of columns. The logical structure is that defined by the logical constitutional requirement of the document specified in SGML (Standard Generalized Mark-up Language) or XML. The meta structure includes not only the logical structure of the text but also the information structure relating to information attached to the document or the semantic content present in the text.

A compound document includes another document in a layer of the logical structure in a compound manner, and in addition, can be recognized as a single document in the representation.

In the compound document using the technique of an existing OLE or the like, however, layout, process, and data are integrated in units of a document object inextricably linked. This makes it difficult to freely operate an arbitrary partial unit of information included in an individual object, so the meta structure is static.

Conversely, as long as a unit of information is marked up as a document element or an attribute in XML, the information is operable on the basis of an appropriate granularity in various manners. It is possible to additionally complement the meta structure by use of a common meta structure description language, such as an RDF (Resource Description Framework).

1-2. Gap in Recognition

The original purpose of the document is distributing information and knowledge, so that one who distributes and another who receives share the common recognition. In addition, a new intelligent value is created on the basis of the common recognition. For a contract document, persons involved agree on the contents of the contract, and business grows based on the contract document, and then a value is created. For a written report, a reporter and a person who receives the report share accurate information, thereby leading to a correct judgment or behavior of the person who receives the report.

There are standardizations of business protocols and templates of business documents, as results of the efforts for standardization and rationalization of the above recognition. These are highly effective; however, on the other hand, cannot eliminate all gaps in the recognition. The gap in the recognition that prevents the mutual understanding arises from the description content on the face of it; however, mainly arises from the diversity of the meta structure at the deep level, in particular, the structure relating to the semantic content.

The meta structure is diverse, because the mental model of the writer and that of the reader are not always the same. This is suggested by an example case where the information important to the writer is not necessarily important to the reader, or by another example case where the document that was written by an expert by use of technical terms is difficult for the reader who is not an expert to understand the content thereof.

The mental model of the writer and that of the reader are produced individually and dynamically. Therefore, it is difficult to fill the gap in the recognition, in the document communication by which the reader makes efforts for adapting the only description presented by the writer to the mental model of the reader.

The ideal document processing environment would include a mechanism whereby the mental model of the writer is made to match the mental model of the reader.

1-3. Relationship of Partial Information in Documents Scattered in a Wide Area

Computerized documents are scattered and present in a wide area. From the structural viewpoint, the respective documents are not present independently, but mutually have structural relationships. An example is web information. The web information is represented in a graph structure of a wide area by means of hyperlinks explicitly expressed. Even a business document that does not have an explicit hyperlink relationship could be considered to have an equivalent structural property in a virtual way.

Taking a fabless company as an example, since the fabless company mainly produces design specifications in the upstream operations, specification documents and design documents are mainly handled. The partial information of the specification document or the design document is also for use in a purchase order issued to a manufacturer, and is possibly quoted in a written sales proposal of the sales department. Also, the value of the partial information is related to account information, an expense item in the purchase order or that in the acceptance order, in the fabless company.

Assuming that each piece of the partial information is a link node, the above relationships form an implicit hyperlink structure. That is to say, since the invention of the printing machinery, the documents had been the information bodies of strong binding in a paper medium. However, the structure of co-reference or cross reference is naturally constructed in units of a part of the document, under the circumstances where the documents are transformed to the computerized documents with no physical limitations and are shared over the network.

The existing document processing paradigm, in which the above structure is ignored and the information content is processed independently on a document object basis, easily degrades the flexibility in referring to the part, or introduces the inconsistency in that pieces of information that are originally identical are scattered as different contents.

Accordingly, in a new document processing paradigm, it is considered natural to handle the computerized documents scattered in a wide area as virtual document spaces to be aggregated according to the purpose, while the consistency of parts of the information subject to co-reference or cross reference is being maintained, and to process the documents in consideration of the characteristics thereof.

1-4. Integration of Recognition and Maintenance of Consistency

It is necessary to revise the conventional one-sided or a uniform framework of information distribution so that the recognition of the writer and that of the reader are integrated and the level of mutual understanding is improved. To put in other words, the mutual understanding means that the reader does not always have to follow one and only representation given by the writer, so it is effective to introduce the framework that can absorb the variety of the reader's recognition and vary the representation structure.

The above framework is composed of: a base representation system; a dynamic transforming mechanism of the representation system; and a transformed representation system. The base representation system is represented as single or plural XML vocabularies. The dynamic transforming mechanism of the representation system is a mechanism of restructuring an arbitrary partial unit of the element freely in the plural XML vocabularies. Also, it may be considered as a restructured XML document that is a result of transforming.

In addition, it is important that the partial unit of the identical information be correct consistently in the situation where the computerized documents are scattered in a wide area. To ensure the consistency of information, it is necessary that not only the information be handled on a partial unit basis, but dependency or the verification of validity be managed at the same time.

[2. Semantic Processing by Use of Meta Information]

2-1. Use of Meta Information

The previous chapter has discussed the usefulness of reusing the document, with XML serving as a platform, in units of each of parts constituting the document, while the consistency of the parts is being kept. It is conceivable that this functions in an effective manner, when the unit of information to be reused is appropriately designed as an XML tag set or a schema, in advance.

In fact, however, it is impossible to anticipate the tag sets satisfying all users perfectly in advance, and a part including the free text description is inevitably present in the operation of an actual XML document. Within the predefined range, the information can be restructured only by limited combinations of information.

For these reasons, considerations are given so that the document is reused in a more flexible fashion by use of the meta information relating to the semantic content.

2-2. Automatic Processing of Meta Information

Although there are lots of advantages of using the meta information, such as extraction and selection of arbitrary partial information or accuracy improvement of information retrieval, there is a problem in that manually applying the meta information increases the cost. In particular, it is not realistic to apply the detailed information to the text, in many cases.

Therefore, studies have been made on the automatic extraction of the meta information, and various algorithms have been proposed. Some applications are in practical use, and an individual name extraction and dependency parsing are incorporated into a text mining system.

The meta structure of the document has been discussed in “1-1”. The information like bibliographical one is, in some cases, applied explicitly at the time of document creation. In a research paper or the like, there is a possibility of enabling the extraction relatively easily by use of the automatic processing, because it is easy to identify such information in the research paper or the like by use of the logical structure.

Meanwhile, it is difficult to predefine person, time, place and the relationships therebetween included in an unformatted sentence to which no tag is given, and the situation of appearance thereof is irregular. Thus, they can be used explicitly by formalizing ex post facto, as a meta information set with respect to the original document by use of the core technique, etc. relating to the automatic extraction of the meta information.

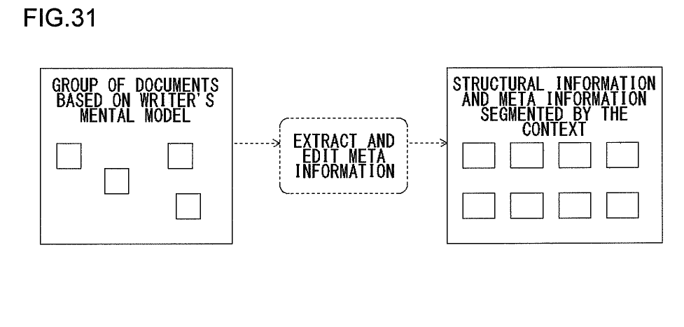

FIG. 31 is a schematic diagram which shows an embodiment of the extraction and segments of the meta information.

2-3. Method of Managing Meta Information

Two methods are conceivable for creating and managing the ex-post meta information with respect to the original information. One is a method of managing the meta information in an integrated manner, by applying all meta information tags of the finest granularity to a single meta information object. The other is a method of individually managing plural meta information objects segmented on the basis of a given segmentation rule. The given segmentation rule is, for example, an arbitrary theme relating to person, such as researcher-theme of research, or an event relating to a business activity such as project-scale-success and failure.

In the above two methods, the former method has the possibility that a single giant DOM is formed. Thus, there are problems in that the granularity of information needs to be designed carefully before the creation of the DOM, and the operation becomes slow. Therefore, it is desirable to manage the meta information as plural meta information contexts like the latter method, so the variety is ensured by adding or combining the plural meta information contexts as necessary.

If it is assumed that a group of the meta information anaphoric to a certain context is handled as a management unit and plural meta information contexts are referred to as a context layer having the functionality of superimposing the contexts as layers, the whole meta information of a document can be represented as a context layer group.

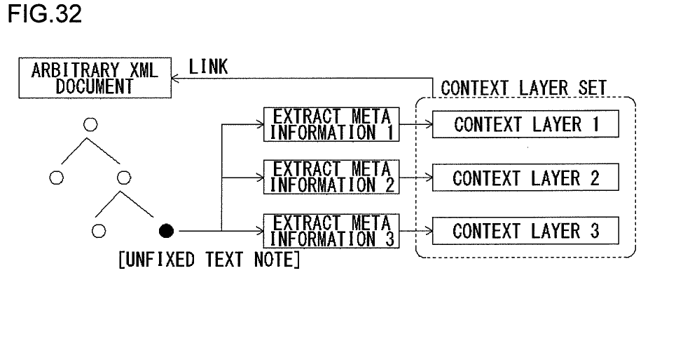

FIG. 32 is a schematic diagram which shows the correspondence between the meta information and the context layer.

2-4. Mechanism of Integrating Recognition by Use of Meta Information

A given document and a context layer group are managed in pairs, thereby allowing restructuring the information on the basis of the meta information. The context layer group can be managed by storing the group in a repository together with linking the group to the original document. To access the information in the repository, an API (Application Program Interface) is provided. The context layer group may be stored in a dedicated storage such as an XML-DB.

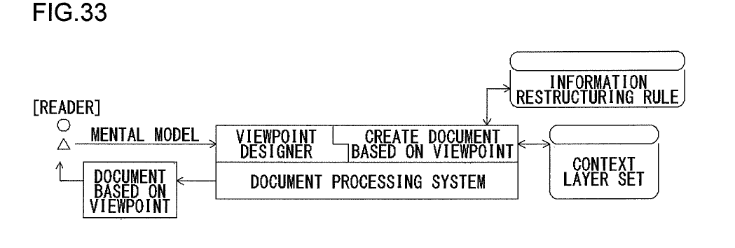

The reader configures a viewpoint based on the mental model, namely, his/her context, and presents the viewpoint to the document processing system. Specifically, this means that conditions including the range, granularity, amount, etc. of the information to be referred to are edited by a GUI. The document processing system dynamically composes a document based on the reader's mental model, by applying the structural partial information or the meta information of the original document to the constitutional elements thereof according to the rule. FIG. 33 is a schematic diagram which shows an embodiment of the document creation based on the reader's mental model.

The above framework permits restructuring information by an arbitrary granularity on the basis of the meta information. That is to say, the above framework enables transforming to the representation of information, whereby the recognition is easiest for the reader.

It is possible to compose different documents according to the situation by use of a written sales report group. For example, a division manager may like to read the summary of sales activities of the past fiscal year so as to make business plans, or a human resources department may like to know the situations of excellent sales activities so as to decide an award.

Even in the situation where the documents are scattered in a wide area, transparent reuse of information is available based on the semantic content of the document by standardizing the operation on the document, the anaphoric context layer group, and the meta information primitive.

[3. Framework of the Present System]

3-1. Basic Concept of Present System

The present system has the basic concept in which any XML document is handled transparently on a single platform, so as to perform the semantic document processing.

The whole document processing environment, in which the present system handles a document in accordance with the viewpoints of XML, is considered to be the framework of the present system. The framework of the present system encompasses all functionalities whereby a new generation of document processing, described heretofore, can be performed.

To put in other words, arbitrary partial information of a document group systemized by semantic and structural description of XML is freely combined, rearranged, or transformed, thereby eliminating the gap in the recognition between the writer and the reader. The present framework has the environment that covers the functionalities supporting the creation of knowledge, while maintaining the consistency of the partial information scattered in a wide area.

3-2. Design of Framework Provided by Present System

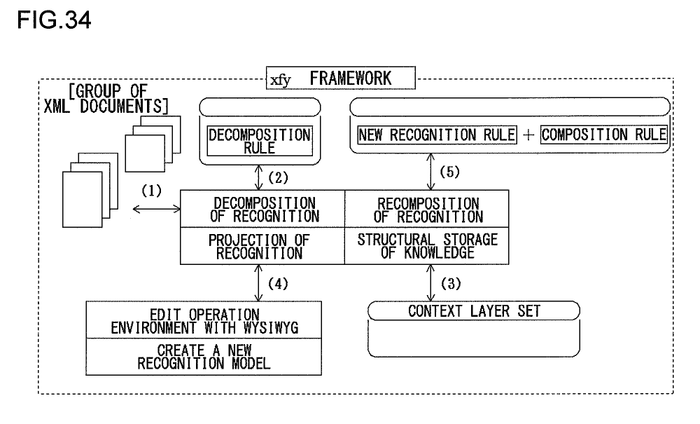

FIG. 34 is a schematic diagram which shows the framework provided by the present system.

The figure shows conceptual functionalities of the present system by four categories in rectangles at the center. The four categories are “decomposition of recognition”, “projection of recognition”, “structural storage of knowledge”, and “recomposition of recognition”. Also, in the figure, numerals represent interactions of the constitutional elements in the framework, the interactions being strongly linked to the functionalities, respectively.

(1) represents the reception of all types of XML. Then, “decomposition of recognition” represents that the writer's mental model is decomposed by the process indicated by (2) into the granularity of information based on the “decomposition rule”. The decomposition rule means the XML vocabulary, a meta information extracting module, or the like.

The group of the partial information assumed to be reused is stored as context information by the process of (3) in the “structural storage of knowledge”.

The reader's mental model is composed with the partial information semantically systemized with a sufficient granularity by means of the edit operation with WYSIWYG, and is reflected to the framework. In this process, the method of composing a new recognition model may be incorporated programmatically as a composition rule.

An arbitrary reader or an information user performs “recomposition of recognition” by use of (5) “recognition model” and “composition rule”, according to the mental model thereof, so as to compose the view most suitable therefor as an XML compound document.

[4. Conclusion]

In an embodiment, a description has been given that the present system encompasses the characteristic functionalities of handling the constitutional element of the document on an arbitrary granularity basis, linking an arbitrary process module including the semantic processing dynamically, and providing the operability with WYSIWYG, whereby the present system could be a framework suitable for a new document processing platform that overcomes the limits of the conventional document concept.

[5. Additional Remarks]

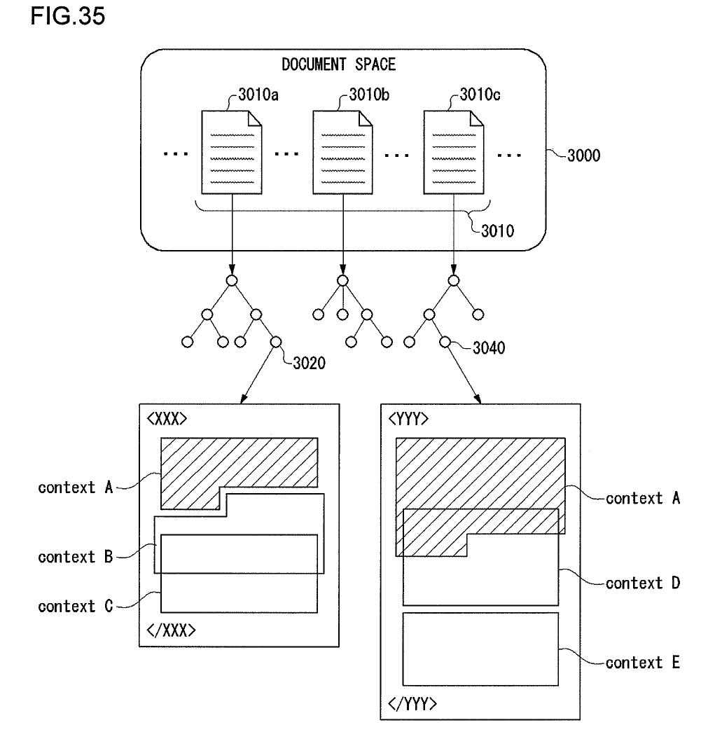

FIG. 35 is a schematic diagram which shows the correspondence between documents and contexts. In the present embodiment, one or more source files 3010 are subject to the processing. The source file 3010 is a document file in which various types of information are represented as text data. The aggregate of such a wide variety of information included in the source file 3010 will be referred to as “document space 3000” in the present embodiment. The document space 3000 may be composed of, for example, a document file stored in an in-house database. Alternatively, the document space 3000 may be composed of a document file, such as an HTML file or an XML file, available through the Internet.

The main purpose of a document processing apparatus according to the present embodiment is that a reader who is a user searches for necessary information in an efficient manner from a given document space 3000 including miscellaneous information, and combines the information as a view file. In the figure, the source files 3010 constituting the document space 3000 will be described as a structured document file written in XML, the source files 3010 including a source file 3010a, a source file 3010b, a source file 3010c, etc.

The tag structure of each source file 3010 can be represented as a DOM tree.

The tag sets for the source files 3010 are not always standardized. To be precise, the tag sets are not standardized, in many cases. The source file 3010a, the source file 3010b, and the source file 3010c will be described herein as using different tag sets. Firstly, attention will be focused on a node 3020 of the source file 3010a.

The node 3020 corresponds to a given element of the source file 3010a. In the DOM tree, data processing may be performed on a node basis. The text data included as a content of the node 3020, however, has possibilities of encompassing various semantic contents. That is to say, when the text data of the node 3020 is further segmented, the segmented data can be classified into several parts according to the content, in some cases. In the figure, the text data of the node 3020 can be classified into three types of text data including: a context A, a context B, and a context C. Hereinafter, data corresponding to the context will be referred to as “context data”.

The context described above is a criterion for classifying the data from a given viewpoint. The user is able to determine the context arbitrarily. As described above, there are three conceivable information structures including the logical structure, layout structure, and meta structure as criteria for determining the context. In FIG. 35, it is assumed that the context is based on the meta structure, and the context A, the context B, and the context C are defined. Firstly, the context based on three information structures will be described.

a) Logical Structure

The logical structure is a document structure explicitly configured to define the document structure such as a tag or attribute in the structured document file. For example, the tag having the name of “vehicle” and the tag having the name of “car” are different in the name, but similar in the meaning. It can be regarded that text data A identified by the tag “vehicle” in one source file 3010 and text data B identified by the tag “car” in another source file 3010 have an analogous relationship in the content. It may be regarded that the text data A and the text data B belong to the same context. The tag “rose” and the tag “flower” have a parent-child relationship such that the former tag is a conception narrower than the latter one. In this process, the text data identified by the tag “rose” may be included in the context “flower”. In this way, the context may be defined by referring to a dictionary table in which a synonym relationship or parent-child relationship of tag names is predefined.

b) Layout Structure

The layout structure is explicitly configured to define the display format of the source file 3010 such as a display font of the text data or an arrangement in the document. When the context is defined according to the layout structure, the context may be determined by referring to a CSS file that forms a set with the source file 3010. A group of text data written in “bold letters” may belong to the same context as a “group of emphasized information”.

c) Meta Structure

As described, the meta structure can be categorized into explicitly-represented meta structure (hereinafter, referred to as “explicit meta structure”) and implicitly-represented meta structure (hereinafter, referred to as “implicit meta structure”). The explicit meta structure is configured by an item explicitly appearing in the text data of the source file 3010. For example, the context may be defined by a chapter such as “the X chapter” or “the Y section” or by a standardized item such as “Background Art” in the patent description.

Meanwhile, the implicit meta structure is a semantic structure that is formed with text data. The implicit meta structure may define three types of contexts including, for example, “positive writing”, “negative writing”, and “neutral writing”. As a method for determining the semantic content of such writing, a known natural language processing technique such as Bayesian Filter may be applied.

There are infinite variations in the method of defining the context from viewpoints of the logical structure, layout structure, and meta structure, so the user who is a reader is able to configure the context from an arbitrary viewpoint. The contexts based on the logical structure, layout structure, and meta structure may be combined arbitrarily. For example, it may be configured such that the text data identified by the tag “vehicle” and the text data including a description relating to cars belong to the same context.

In the node 3020 shown in the figure, it is assumed that the context A, the context B, and the context C are extracted from a given viewpoint based on the implicit meta structure.

A node 3040 corresponds to a given element of the source file 3010c. Attention will now be focused on the node 3040. The text data of the node 3040 includes three types of the context data including: the context A; a context D; and a context E, from a given viewpoint based on the above implicit meta structure. It is to be noted that the source file 3010a and the source file 3010b, which are originally different source files 3010, both include the context data corresponding to the context A (hereinafter, such context data will be simply referred to as “context data A”). That is to say, when viewing the document space 3000 with the attention focused on the context, the context data A is present in the source file 3010a and in the source file 3010c in a separate manner, in the document space 3000. It is common that the information having a high correspondence is scattered in plural source files 3010 as a result, not only in the case where plural source files 3010 implicitly have correspondences by hyperlink, but also in the case where there is no implicit link.

The document processing apparatus according to the present embodiment is capable of collecting the data corresponding to the desired context in an efficient manner and in units of arbitrary information, from the document space 3000 including such plural source files 3010.

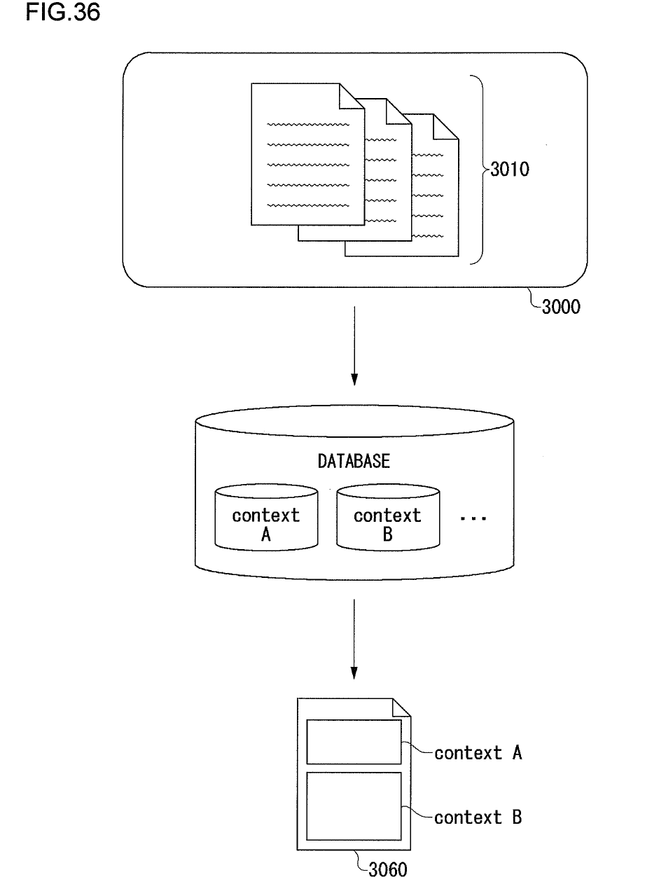

FIG. 36 is a schematic diagram which explains the principle of generating a view file from the source file. Firstly, plural types of context data are extracted from the document space 3000 according to a given context. Such plural types of context data are classified by the context and retained in a database. A view file 3060 is created from the database. The user who is a reader is able to design the view file arbitrarily. In the figure, the view file 3060 is created with the context data A and the context data B enumerated. The view file 3060 is also created as an XML document file.

When this process is viewed from the mental model, it is obvious that the writer's mental model is changed to the reader's mental model. It should be understood that the source file 3010 is created in the writer's mental model. The information included in the source file 3010 is extracted, classified, and aggregated into the database according to a given context. The context may be defined on the basis of the reader's mental model, or may be defined from a given common viewpoint. Finally, the reader creates the view file 3060 according to the mental model thereof. In this manner, it is designed that the writer's mental model and the reader's mental model are matched by the segmentation and recomposition based on the context of the information in the source file 3010.

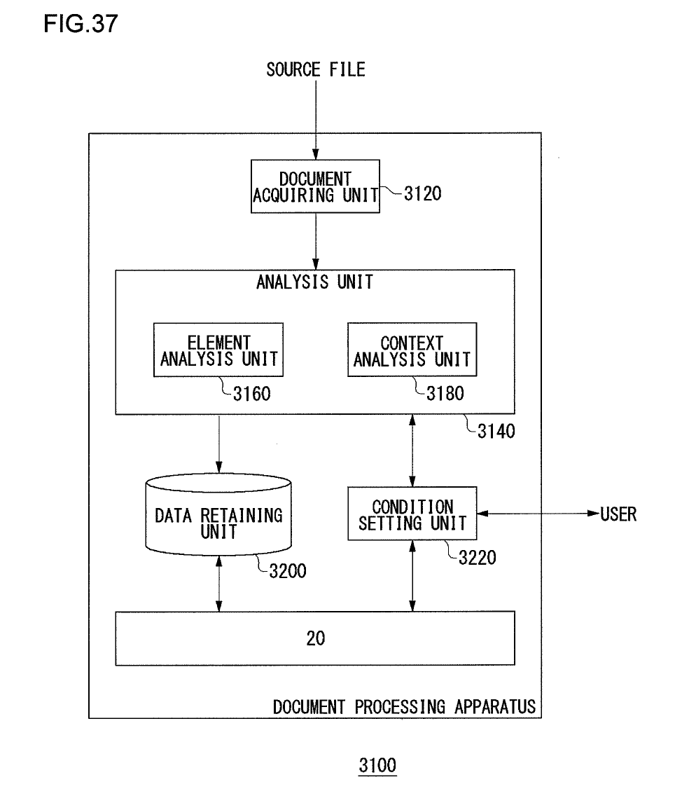

FIG. 37 illustrates a functional block diagram of the document processing apparatus according to the present embodiment.

Each of the functional blocks shown in the figure is accomplished by a device or a machine including a CPU of a computer in terms of hardware, and is accomplished by a computer program or the like in terms of software. The figure shows the functional blocks accomplished by cooperation thereof. It therefore should be understood by those skilled in the art that these functional blocks are accomplished in various manners by software, hardware, and combinations thereof.

A document processing apparatus 3100 is provided with: the document processing apparatus 20, described in the Prerequisite Technology of the Present Invention; a document acquiring unit 3120; an analysis unit 3140; a data retaining unit 3200; and a condition setting unit 3220.

The document acquiring unit 3120 acquires the source file 3010. The analysis unit 3140 analyzes the acquired source file 3010 and extracts context data therefrom. The data retaining unit 3200 retains the extracted context data, which corresponds to the database in FIG. 36. The condition setting unit 3220 sets a browsing condition for identifying the context data included in the view file 3060 according to the input from the user. The tag structure of the view file 3060 is also set as a browsing condition. The browsing condition is reflected as a definition file of the document processing apparatus 20. According to the browsing condition, the document processing apparatus 20 creates the view file 3060 from the data in the data retaining unit 3200. The condition setting unit 3220 sets a display condition of the view file 3060. According to the display condition, the view file 3060 is displayed on the screen. The condition setting unit 3220 also sets a method of defining the context in the analysis unit 3140. The above conditions allow the user who is a reader to extract information from an arbitrary viewpoint and display the information in an arbitrary display format and in an arbitrary structure.

The analysis unit 3140 includes: an element analysis unit 3160; and a context analysis unit 3180.

The element analysis unit 3160 performs a syntax analysis on a text in the source file 3010 to be processed, and extracts a component of the text as element data. For example, if there is a sentence “A went to B in 2005”, this sentence can be decomposed into four constitutional elements (hereinafter, referred to as “element data”) including “A” as a subject, “B” as an object, “went” as a predicate, and “in 2005” representing date. The data retaining unit 3200 may structuralize each piece of the element data and retains the element data in RDF format. The context analysis unit 3180 determines the context of the sentence according to each piece of the element data. For example, when the context is defined from the viewpoint of “positive writing” or “negative writing” and the element data corresponding to the predicate is a positive one such as “was good” or “is able to”, the context may be determined as a positive one. In this manner, when the context is defined according to the meta information, the context analysis unit 3180 reviews the property of the sentence from the element data and determines that a group of text data belonging to the same context belong to a given context.

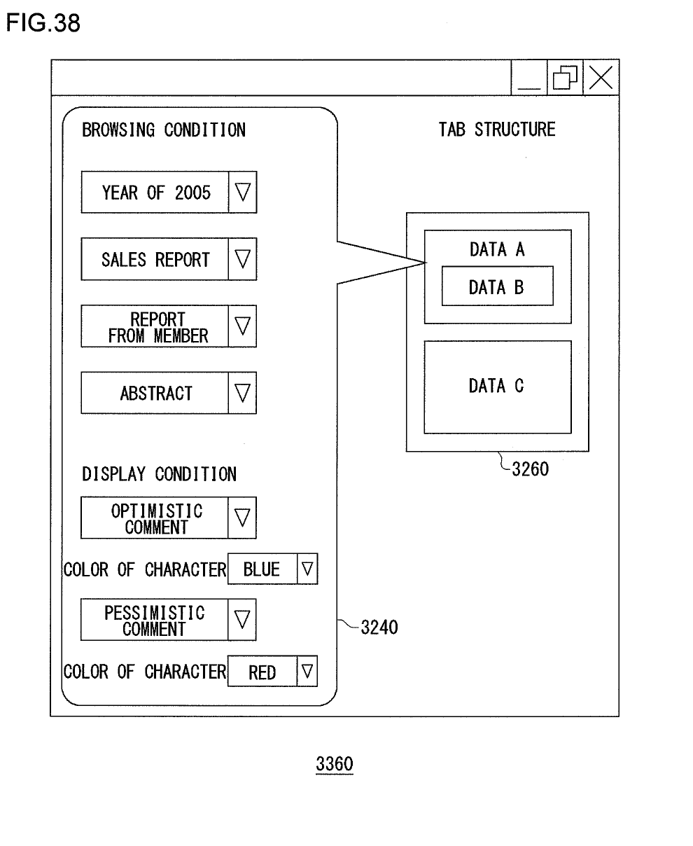

FIG. 38 illustrates a screen for setting the configuration of the view file.

A tag structure setting area 3260 in a setting screen 3360 is an area for designing the tag structure of the view file 3060. In the figure, three pieces of data including: data A; data B; and data C, are the elements. The element corresponding to the data B is a child element of the element corresponding to the data A.

When a user executes a given operation while selecting the data A of the tag structure setting area 3260, a condition setting area 3240 is displayed. The condition setting area 3240 is an area for setting the browsing condition for identifying the content of the data A and the display condition for showing the display method. In the figure, “abstract” of “report from sales member” regarding “sales report” in “2005” is designated as the data A. That is to say, data matching all of the above four contexts is the condition for the data A. Also, of the data A, it is configured such that an optimistic comment is displayed in blue and a pessimistic comment is displayed in red. The “abstract” of “report from assistant manager” regarding “sales report” in “2005” may be designated as the data B. The context data extracted from the report on marketing may be designated as the data C. The reader may be able to configure the display format of the data such as graph display or text display, arbitrarily.

As described heretofore, by use of the document space 3000, the view file 3060 matching the reader's mental model both in the structure and in the representation format can be designed with ease.

As described heretofore, the document processing apparatus 3100 according to the present embodiment permits providing the scheme for matching the writer's mental model with the reader's mental model in an effective manner. The above scheme allows the reader to collect data freely from the document space 3000 including miscellaneous information. For instance, a past issue of an electronic magazine published on a regular basis is configured as the document space 3000, thereby allowing collecting information demanded by a reader and creating a digest version with ease. If the content of the original source file 3010 is changed, the document processing apparatus 3100 may receive a notification of the change from the source file 3010. The document processing apparatus 3100, upon receiving the notification of the change, may reacquire the source file 3010 subjected to the change and re-extract the context data.

The description of the invention given above is based upon an embodiment. The embodiment is illustrative in nature and various variations in constitutional elements and processes involved are possible.

### INDUSTRIAL APPLICABILITY

According to the present invention, it is possible to provide the technique of structuring and processing data in a document file in an appropriate manner.

1. A document processing apparatus comprising:
a document acquiring unit which acquires a document file from an external apparatus;
a meta information extracting unit which refers to context information in which one or more contexts are defined as a segment for classifying data in accordance with a given criterion and extracts meta information in accordance with each context from the data included in the acquired document file; and
a related information storage which stores related information representing that a group of the meta information corresponding to each context is the data extracted from the acquired document file.

2. The document processing apparatus according to claim 1, further comprising:
a structure definition file storage which stores a structure definition file in which a document structure corresponding to the each context is defined in accordance with the context information; and
a document creator which creates the document file in the document structure defined by the structure definition file, from the group of the meta information classified in accordance with the each context.

3. The document processing apparatus according to claim 1, further comprising:
an input screen display unit which displays an input screen for defining the context information; and
an operation input unit which receives an input for defining the context information entered by a user through the input screen,
wherein the meta information extracting unit extracts the meta information in accordance with the context information defined by the user through the input screen.

4. A document processing apparatus comprising:
a document acquiring unit which acquires a document file to be browsed as a source file;
a context analysis unit which refers to context information in which one or more contexts are defined as a segment for classifying data in accordance with a given criterion and extracts context data that matches each context from the source file; and
a document creator which refers to a browsing condition, which is a condition designated by a reader, for identifying the one or more contexts to be browsed and defining a structure of the document file newly created from the context data that matches the each context, so as to create a view file as the document file in which the context data to be browsed is structured.

5. The document processing apparatus according to claim 4, further comprising an element analysis unit which extracts element data from the source file in units constituting a semantic structure of a text as a component of a sentence,
wherein the context analysis unit extracts the context data including one or more pieces of the element data on the basis of the context formed by a group of the element data.

6. The document processing apparatus according to claim 4, wherein the context analysis unit extracts the context data from the source file on an item basis, the item being provided in the sentence.

7. The document processing apparatus according to claim 4, wherein:
layout information for displaying is applied to the source file; and
the context analysis unit extracts the context data from the source file in a constitutional unit to be displayed on the layout information.

8. The document processing apparatus according to claim 4, further comprising a display processor which refers to a display condition for defining a method of displaying the context data to be browsed, and identifies the method of displaying the view file.

9. The document processing apparatus according to claim 4, wherein the document creator is adapted to create a single view file from the context data extracted from a plurality of types of the source files.

10. A document processing method comprising:
acquiring a document file to be browsed as a source file;
referring to context information in which one or more contexts are defined as a segment for classifying data in accordance with a given criterion to extract context data that matches each context from the source file; and
referring to a browsing condition, which is a condition designated by a reader, for identifying the one or more contexts to be browsed and defining a structure of the document file newly created from the context data that matches the each context, so as to create a view file as the document file in which the context data to be browsed is structured.

11. A document processing program product comprising:
acquiring a document file to be browsed as a source file;
referring to context information in which one or more contexts are defined as a segment for classifying data in accordance with a given criterion to extract context data that matches each context from the source file; and
referring to a browsing condition, which is a condition designated by a reader, for identifying the one or more contexts to be browsed and defining a structure of the document file newly created from the context data that matches the each context, so as to create a view file as the document file in which the context data to be browsed is structured.
